(19) United States
(12) Patent Application Publication
(10) Pub. No.: US 2018/0051149 A1
(43) Pub. Date: Feb. 22, 2018

(54) HARDCOAT FILM, POLARIZING PLATE, AND TOUCH PANEL DISPLAY

(71) Applicant: FUJIFILM Corporation, Tokyo (JP)

(72) Inventors: Tatsuya IWASAKI, Kanagawa (JP); Taketo OTANI, Kanagawa (JP)

(73) Assignee: FUJIFILM Corporation, Tokyo (JP)

(21) Appl. No.: 15/790,475

(22) Filed: Oct. 23, 2017

Related U.S. Application Data
(63) Continuation of application No. PCT/JP2016/057923, filed on Mar. 14, 2016.

(30) Foreign Application Priority Data
Apr. 24, 2015 (JP) 2015-089472

(51) Int. Cl. C08J 7/16; C09D 4/06; G02F 1/1335; G02B 1/14

(52) U.S. Cl. CPC C08J 7/16; C09D 4/06; G02F 1/133528; G02F 1/13338; C08J 2301/10; C08J 2451/00; C08J 2333/12; G02B 1/14

(57) ABSTRACT

Provided is a hardcoat film including a support and a hardcoat layer on at least one surface of the support. The hardcoat layer is formed of a composition for forming a hardcoat layer. The composition contains: (a) resin having a group which increases hydrophilicity when decomposed by an acid and a group which contains at least one kind of atom selected from a fluorine atom and a silicon atom; and (b) acid generator.

### CROSS REFERENCE TO RELATED APPLICATIONS

This is a continuation of International Application No. PCT/JP2016/057923 filed on Mar. 14, 2016, and claims priority from Japanese Patent Application No. 2015-089472 filed on Apr. 24, 2015, the entire disclosures of which are incorporated herein by reference.

### BACKGROUND OF THE INVENTION

### 1. Field of the Invention

The present invention relates to a hardcoat film, a polarizing plate, and a touch panel display.

### 2. Description of the Related Art

In image displays such as a cathode ray tube display (CRT), a plasma display (PDP), an electroluminescence display (ELD), a vacuum fluorescent display (VFD), a field emission display (FED), or a liquid crystal display (LCD), in order to prevent a display surface from being scratched, it is suitable for a hardcoat film having a hardcoat layer to be provided on a support.

In recent years, as the image displays have been diversified for being used as a touch panel or the like, a demand for laminating (recoating) other functional layers on the hardcoat layer has increased. Accordingly, there is a demand for a hardcoat layer that is easily laminated on other layers, that is, a hardcoat layer that exhibits excellent laminating properties (recoating properties) with respect to other layers. In a case where recoating is performed on the hardcoat layer, unless the surface of the hardcoat layer is hydrophilic and has high wettability, the overlayer undergoes the impairment of homogeneity (surface smoothness) such as cissing failure or coating thickness unevenness. Generally, in order to improve the homogeneity of the coating film of the hardcoat layer itself, a leveling agent such as a silicone-based compound or a fluorine-containing polymer is added to the hardcoat layer. Due to the hydrophobicity of the leveling agent, the surface of the hardcoat layer is hydrophobized, and accordingly, a trade-off between the surface condition of the hardcoat layer and the recoating properties becomes an issue.

As a method for hydrophilizing the surface of the hardcoat layer for recoating properties without impairing the leveling properties of the hardcoat layer, there is a method in which a silicone-based compound or a fluorine-containing polymer is not used. For example, as described in JP2001-272503A, there is a method in which an anionic, nonionic, or betaine hydrocarbon-based surfactant is used as a leveling agent. Furthermore, JP2011-212554A describes that leveling properties are conferred by using a certain amount of solvent whose boiling point and viscosity are within a specific range without using a surfactant.

As another hydrophilizing method, JP2001-272503A describes a method in which a corona discharge treatment or a glow discharge treatment is performed after a hardcoat layer is formed by coating such that the surface is hydrophilized.

### SUMMARY OF THE INVENTION

However, because the hydrophobicity of the hydrocarbon-based surfactant described in JP2001-272503A is poorer than that of a silicone-based compound or a fluorine-containing polymer, the leveling properties are impaired. Furthermore, with the method described in JP2011-212554A in which a surfactant is not used, in a case where the solvent volatilizes in the process of drying a coating film, because the remaining composition for forming a hardcoat layer has high surface tension, the homogeneity of the coating film is likely to be impaired until the coating film is cured. Therefore, a strict control, which is extremely difficult, is required such that the solvent volatilizes immediately before curing. In addition, in the method described in JP2001-272503A in which a discharge treatment such as a corona treatment is performed after film hardening, the productivity deteriorates due to the increase in the number of processes, and because the film is irradiated with high energy, film deformation, pinhole formation, hydrophilicity unevenness within the surface, and the like occur in some cases.

Objects of the present invention are to provide a hardcoat film which has excellent surface condition and hardness, has a small contact angle with respect to water on a surface thereof, and exhibits excellent laminating properties with respect to other layers, and to provide a polarizing plate and a touch panel display having the hardcoat film.

In order to achieve the aforementioned objects, the inventors of the present invention performed an intensive examination. As a result, they have found that by adding a resin, which has at least one kind of atom selected from a fluorine atom and a silicon atom and has a group which experiences an increase in hydrophilicity by being decomposed by the action of an acid, as a surfactant to a composition for forming a hardcoat layer and reacting the composition with an acid, it is possible to prepare a hardcoat film which has excellent leveling properties, has a surface small contact angle with respect to water on a surface thereof, and exhibits excellent laminating properties with respect to other layers.

That is, the aforementioned objects can be achieved by the following constitution.

<1> A hardcoat film comprising a support and a hardcoat layer on at least one surface of the support, in which the hardcoat layer is formed of a composition for forming a hardcoat layer containing: (a) resin having a group which increases hydrophilicity when decomposed by an acid and a group which contains at least one kind of atom selected from a fluorine atom and a silicon atom; and (b) acid generator.

<2> A hardcoat film obtained by treating a hardcoat layer with an acid, the hardcoat layer disposed on at least one surface of a support, in which the hardcoat layer is formed of a composition for forming a hardcoat layer containing (a) resin having a group which increases hydrophilicity when decomposed by an acid and a group which contains at least one kind of atom selected from a fluorine atom and a silicon atom.

<3> The hardcoat film described in <1> or <2>, in which in the resin (a), the group which increases hydrophilicity when decomposed by an acid has a substituent which contains at least one kind of the atom selected from a fluorine atom and a silicon atom.

<4> The hardcoat film described in any one of <1> to <3>, in which the composition for forming a hardcoat layer further contains (c) compound having three or more ethylenically unsaturated double bond groups.

<5> The hardcoat film described in any one of <1> to <4>, in which the composition for forming a hardcoat layer further contains (d) compound having one or more epoxy groups.

<6> The hardcoat film described in <5>, in which the compound (d) has one alicyclic epoxy group and one ethylenically unsaturated double bond group in a molecule and having a molecular weight of equal to or less than 300.

<7> The hardcoat film described in any one of <1> to <6>, in which the composition for forming a hardcoat layer further contains (e) inorganic fine particles reactive with an epoxy group or an ethylenically unsaturated double bond group.

<8> The hardcoat film described in any one of <1> to <7>, in which the composition for forming a hardcoat layer further contains (f) ultraviolet absorber.

<9> The hardcoat film described in any one of <1> to <8>, in which the support is a cellulose acylate film and has a thickness of equal to or less than 25 μm.

<10> A polarizing plate comprising at least one sheet of the hardcoat film described in any one of <1> to <9> and a polarizer.

<11> A touch panel display containing a liquid crystal cell and the polarizing plate described in <10> on a viewing side of the liquid crystal cell.

According to the present invention, it is possible to provide a hardcoat film which has excellent surface condition and hardness, has a small contact angle with respect to water on a surface thereof, and exhibits excellent laminating properties with respect to other layers, and to provide a polarizing plate and a touch panel display having the hardcoat film

### DESCRIPTION OF THE PREFERRED EMBODIMENTS

Hereinafter, the present invention will be specifically described.

In the present specification, “to” means that the numerical values listed before and after “to” are a lower limit and an upper limit respectively.

In the present specification, “(meth)acryl group” means “either or both of an acryl group and a methacryl group”, and the same shall be applied to a (meth)acrylic acid, a (meth)acrylamide, a (meth)acryloyl group, and the like.

[Hardcoat Film]

The hardcoat film of the present invention is a hardcoat film including a support and a hardcoat layer on at least one surface of the support, in which the hardcoat layer is formed of a composition for forming a hardcoat layer containing (a) resin having a group which experiences an increase in hydrophilicity by being decomposed by the action of an acid and a group which contains at least one kind of atom selected from a fluorine atom and a silicon atom and (b) acid generator, or a hardcoat film obtained by treating an hardcoat film including a support and a hardcoat layer on at least a surface of the support with an acid, in which the hardcoat layer is formed of a composition for forming a hardcoat layer containing (a) resin having a group which experiences an increase in hydrophilicity by being decomposed by the action of an acid and a group which contains at least one kind of atom selected from a fluorine atom and a silicon atom.

<Hardcoat Layer>

The hardcoat layer in the hardcoat film of the present invention will be described.

((a) Resin having group which experiences increase in hydrophilicity by being decomposed by the action of acid and a group which contains at least one kind of atom selected from fluorine atom and silicon atom)

The hardcoat layer of the present invention is formed of the composition for forming a hardcoat layer containing (a) resin described above (referred to as “resin (a)” or “(a) component” as well).

[Acid Decomposable Group]

The resin (a) has, on either or both of a main chain and a side chain of the resin, a group (referred to as “acid decomposable group”) which experiences an increase in hydrophilicity by generating a hydrophilic group by being decomposed by the action of an acid.

It is preferable that the resin (a) has the acid decomposable group on a side chain. It is more preferable that the group which experiences an increase in hydrophilicity by being decomposed by the action of an acid is substituted with a group containing at least one kind of atom selected from a fluorine atom and a silicon atom.

It is even more preferable that the resin (a) has a repeating unit having an acid decomposable group on a side chain. It is particularly preferable that the repeating unit having an acid decomposable group is substituted with a group containing at least one kind of atom selected from a fluorine atom and a silicon atom.

It is preferable that the acid decomposable group has a structure protected with a group which eliminates a hydrophilic group by decomposing the hydrophilic group by the action of an acid.

Examples of the hydrophilic group include a phenolic hydroxyl group, a carboxyl group, a fluorinated alcohol group, a sulfonic acid group, a sulfonamide group, a sulfonylimide group, an (alkylsulfonyl)(alkylcarbonyl)methylene group, an (alkylsulfonyl)(alkylcarbonyl)imide group, a bis(alkylcarbonyl)methylene group, a bis(alkylcarbonyl)imide group, a bis(alkylsulfonyl)methylene group, a bis(alkylsulfonyl)imide group, a tris(alkylcarbonyl)methylene group, a tris(alkylsulfonyl)methylene group, and the like.

Examples of preferred hydrophilic groups include a carboxyl group, a fluorinated alcohol group (preferably a hexafluoroisopropanol group), and a sulfonic acid group.

As the acid decomposable group, a group is preferable which is substituted with a group eliminating hydrogen atoms of the above hydrophilic groups by using an acid.

Examples of the group performing elimination by using an acid include —C(R₃₆)(R₃₇)(-R₃₈), —C(R₃₆)(R₃₇XOR₃₉), —C(R₀₁)(R₀₂)(OR₃₉), and the like.

In the above formulae, R₃₆ to R₃₉ each independently represent an alkyl group, a cycloalkyl group, an aryl group, an aralkyl group, or an alkenyl group. R₃₆ and R₃₇ may form a ring by being bonded to each other.

R₀₁ and R₀₂ each independently represent a hydrogen atom, an alkyl group, a cycloalkyl group, an aryl group, an aralkyl group, or an alkenyl group.

As the acid decomposable group, a cumyl ester group, an enol ester group, an acetal ester group, a tertiary alkyl ester group, and the like are preferable, and a tertiary alkyl ester group is more preferable.

As the repeating unit having an acid decomposable group that the resin (a) can contain, a repeating unit represented by General Formula (AI) is preferable.

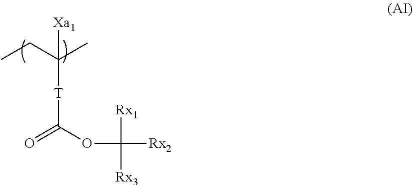

In General Formula (AI), Xa₁ represents a hydrogen atom or an alkyl group which may have a substituent.

T represents a single bond or a divalent linking group.

Rx₁ to Rx₃ each independently represent an alkyl group (linear or branched) or a cycloalkyl group (monocyclic or polycyclic).

Two among Rx₁ to Rx₃ may form a cycloalkyl group (monocyclic or polycyclic) by being bonded to each other.

Examples of the alkyl group which may have a substituent that is represented by Xa₁ include a methyl group or a group represented by —CH₂—R₁₁. R₁₁ represents a halogen atom (such as a fluorine atom), a hydroxyl group, or a monovalent organic group. Examples of the monovalent organic group include an alkyl group having 5 or less carbon atoms and an acyl group having 5 or less carbon atoms. The monovalent organic group is preferably an alkyl group having 3 or less carbon atoms, and more preferably a methyl group. In an aspect, Xa₁ is preferably a hydrogen atom, a methyl group, a trifluoromethyl group, a hydroxymethyl group, or the like.

Examples of the divalent linking group represented by T include an alkylene group, a —COO-Rt- group, an —O-Rt- group, and the like. In the formulae, Rt represents an alkylene group or a cycloalkylene group.

T is preferably a single bond or a —COO-Rt- group. Rt is preferably an alkylene group having 1 to 5 carbon atoms, and more preferably a —CH₂— group, a —(CH₂)₂— group, or a —(CH₂)₃— group.

As the alkyl group represented by Rx₁ to Rx₃, an alkyl group having 1 to 4 carbon atoms such as a methyl group, an ethyl group, an n-propyl group, an isopropyl group, an n-butyl group, an isobutyl group, or a t-butyl group is preferable.

As the cycloalkyl group represented by Rx₁ to Rx₃, a monocyclic cycloalkyl group (preferably a monocyclic cycloalkyl group having 5 to 8 carbon atoms) such as a cyclopentyl group or a cyclohexyl group and a polycyclic cycloalkyl group (preferably a polycyclic cycloalkyl group having 7 to 12 carbon atoms) such as a norbornyl group, a tetracyclodecanyl group, a tetracyclododecanyl group, or an adamantyl group are preferable.

As the cycloalkyl group formed by the bonding between two among Rx₁ to Rx₃, a monocyclic cycloalkyl group such as a cyclopentyl group or a cyclohexyl group and a polycyclic cycloalkyl group such as a norbornyl group, a tetracyclodecanyl group, a tetracyclododecanyl group, or an adamantyl group are preferable, and a monocyclic cycloalkyl group having 5 or 6 carbon atoms is particularly preferable.

In the cycloalkyl group formed by the bonding between two among Rx₁ to Rx₃, for example, one methylene group constituting the ring may be substituted with a heteroatom such as an oxygen atom or with a heteroatom-containing group such as a carbonyl group.

The aforementioned groups may each have a substituent. Examples of the substituent include an alkyl group (preferably having 1 to 4 carbon atoms), a halogen atom, a hydroxyl group, an alkoxy group (preferably having 1 to 4 carbon atoms), a carboxyl group, an alkoxycarbonyl group (preferably having 2 to 6 carbon atoms), a group containing at least one kind of atom selected from a fluorine atom and a silicon atom, and the like, and these preferably have 8 or less carbon atoms. As the group containing at least one kind of atom selected from a fluorine atom and a silicon atom, a fluoroalkyl group (preferably having 1 to 6 carbon atoms) and an alkylsilyl group (preferably having 3 to 8 carbon atoms) are preferable.

The total content of the repeating unit having an acid decomposable group is, with respect to all the repeating units in the resin (a), preferably 20 to 100 mol %, more preferably 30 to 95 mol %, and even more preferably 40 to 90 mol %.

Specific examples of preferred repeating units having an acid decomposable group will be shown below, but the present invention is not limited thereto.

In the specific examples, Rx represents a hydrogen atom, CH₃, CF₃, or CH₂OH. Rxa and Rxb each independently represent an alkyl group having 1 to 4 carbon atoms. Z represents a substituent. The substituent is a fluoroalkyl group (preferably having 1 to 6 carbon atoms), an alkylsilyl group (preferably having 3 to 8 carbon atoms), or a substituent containing a polar group. In a case where there is a plurality of substituents, they are independent from each other p represents 0 or a positive integer. Examples of the substituent containing a polar group represented by Z include a linear or branched alkyl group having a hydroxyl group, a cyano group, an amino group, an alkylamide group or a sulfonamide group and a cycloalkyl group. Among these, an alkyl group having a hydroxyl group is preferable. As a branched alkyl group, an isopropyl group is particularly preferable.

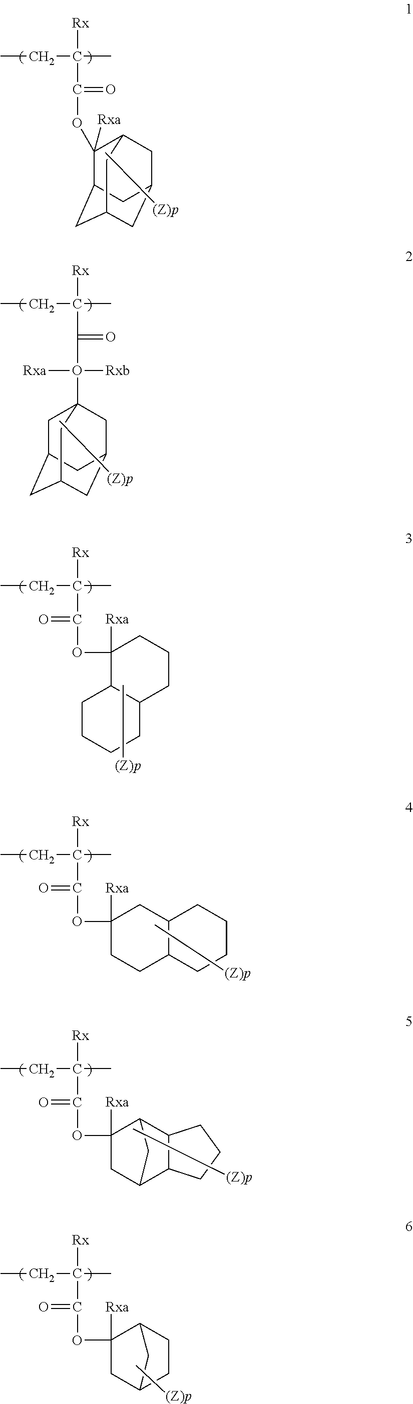

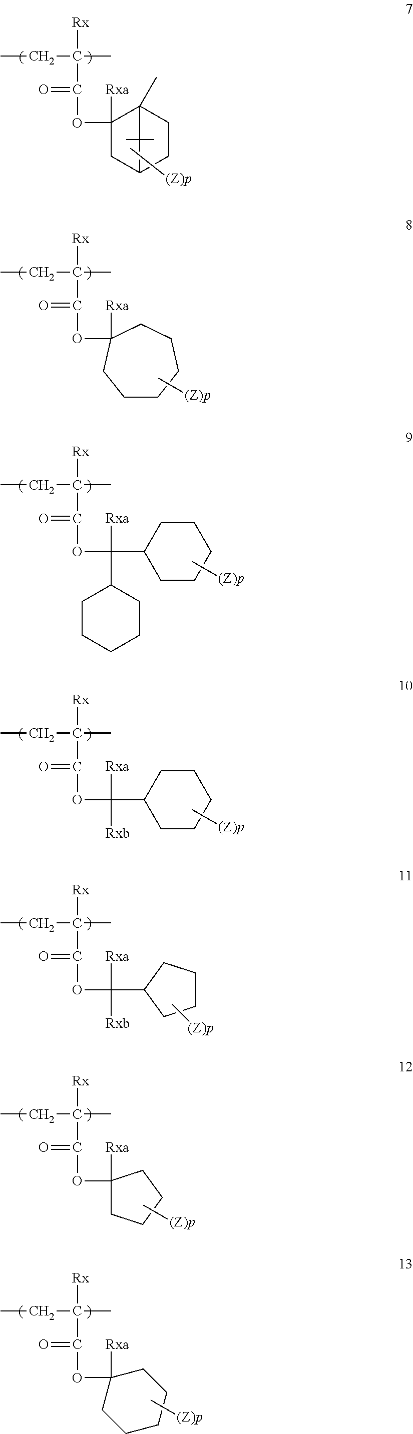

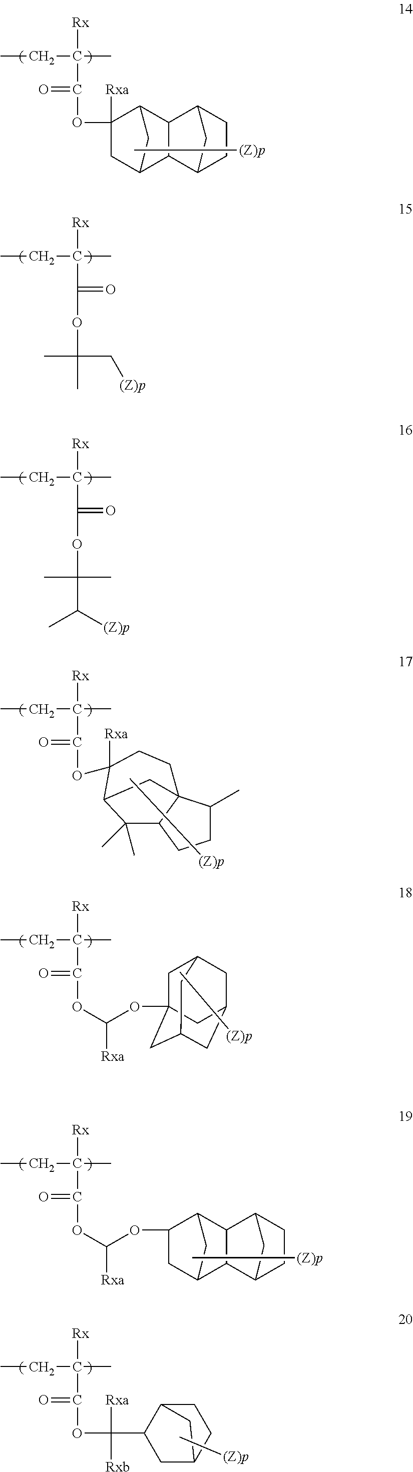

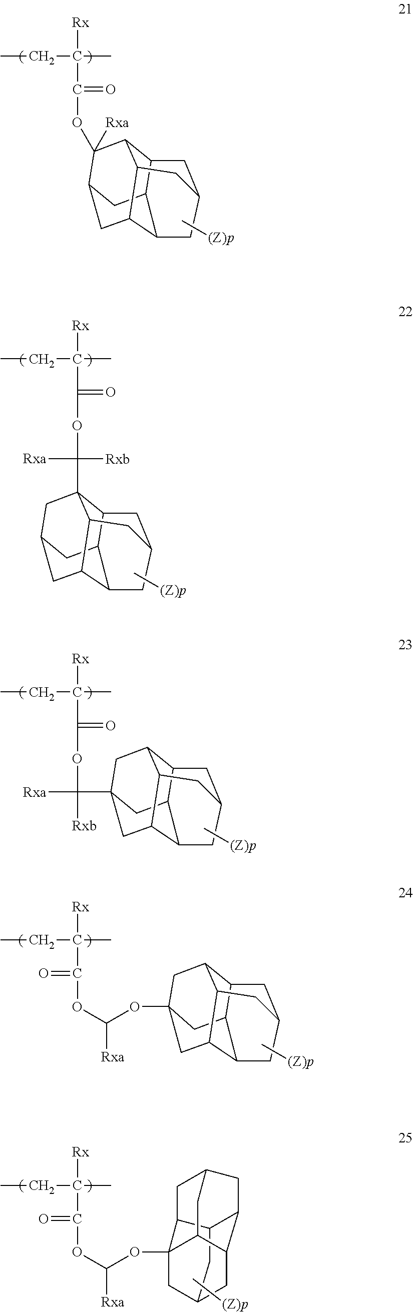

The resin (a) may contain, for example, a repeating unit represented by General Formula (3) as the repeating unit represented by General Formula (A1).

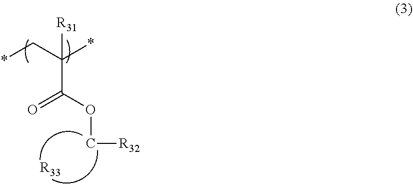

In General Formula (3). R₃₁ represents a hydrogen atom or an alkyl group.

R₃₂ represents a methyl group, an ethyl group, an n-propyl group, an isopropyl group, an n-butyl group, an isobutyl group, or a sec-butyl group.

R₃₃ represents an atomic group necessary for forming a monocyclic alicyclic hydrocarbon structure together with carbon atoms to which R₃₂ is bonded. In the alicyclic hydrocarbon structure, some of the carbon atoms constituting a ring may be substituted with a heteroatom or a group having a heteroatom.

The alkyl group represented by R₃₁ may have a substituent, and examples of the substituent include a fluorine atom, a hydroxyl group, and the like.

R₃₁ preferably represents a hydrogen atom, a methyl group, a trifluoromethyl group, or a hydroxymethyl group.

R₃₂ is preferably a methyl group, an ethyl group, an n-propyl group, or an isobutyl group, and more preferably a methyl group or an ethyl group.

The monocyclic alicyclic hydrocarbon structure that R₃₃ forms together with carbon atoms is preferably a 3- to 8-membered ring and more preferably a 5- or 6-membered ring.

In the monocyclic alicyclic hydrocarbon structure that R₃₃ forms together with carbon atoms, examples of the heteroatom which can form a ring include an oxygen atom, a sulfur atom, and the like, and examples of the group having a hetero atom include a carbonyl group and the like. Here, the group having a heteroatom is preferably not an ester group (ester bond).

The monocyclic alicyclic hydrocarbon structure that R₃₃ forms together with carbon atoms is preferably formed only of carbon atoms and hydrogen atoms.

Specific examples of the repeating unit having the structure represented by General Formula (3) will be shown below, but the present invention is not limited thereto.

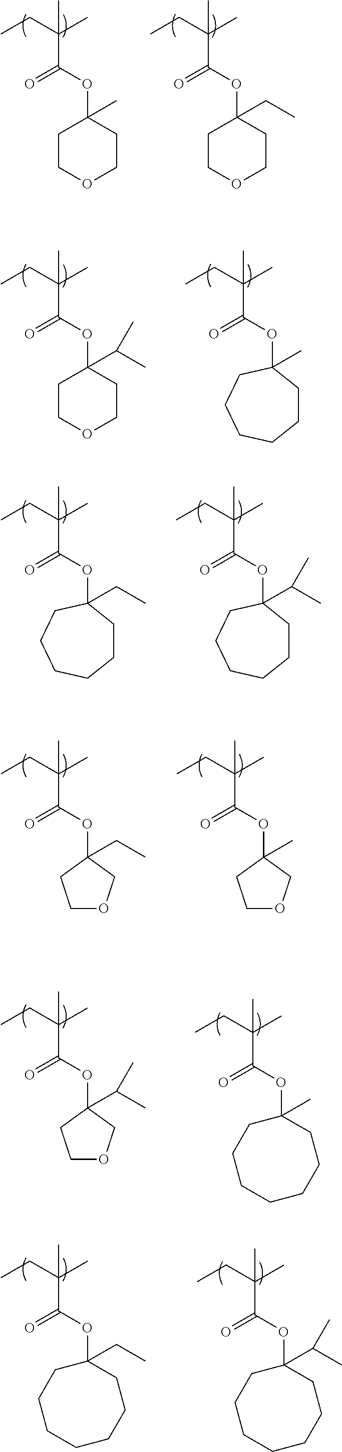

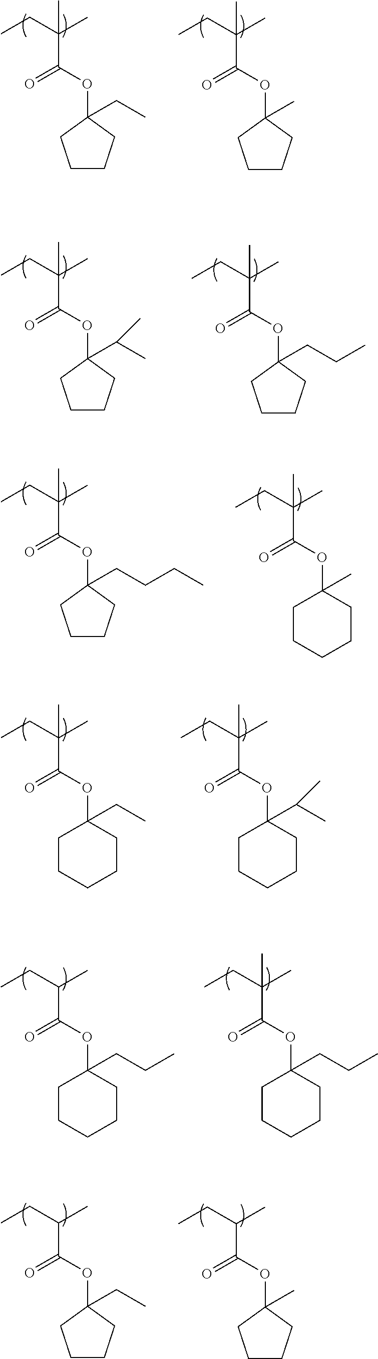

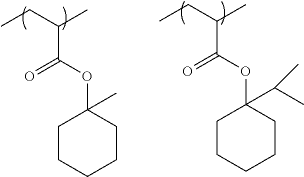

The resin (a) is preferably a resin having, as the repeating unit represented by General Formula (AI), at least any one of a repeating unit represented by General Formula (I) or a repeating unit represented by General Formula (II), for example.

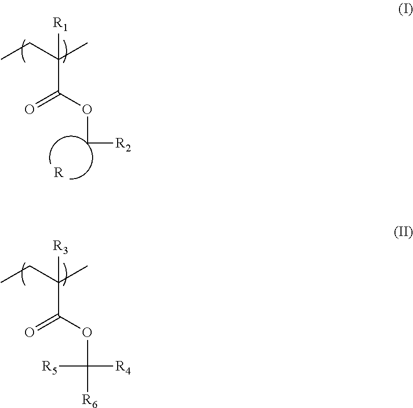

In General Formulae (I) and (II), R₁ and R₃ each independently represent a hydrogen atom, a methyl group which may have a substituent, or a group represented by —CH₂—R₁₁. R₁₁ represents a hydroxyl group or a monovalent organic group.

R₂, R₄, R₅, and R₆ each independently represent an alkyl group or a cycloalkyl group.

R represents an atomic group necessary for forming an alicyclic structure together with carbon atoms to which R₂ is bonded.

R₁ and R₃ preferably represent a hydrogen atom, a methyl group, a trifluoromethyl group, or a hydroxymethyl group. Specific examples and preferred examples of the monovalent organic group represented by R₁₁ are the same as those described above for R₁₁ in General Formula (AI).

The alkyl group represented by R₂ may be linear or branched and may have a substituent.

The cycloalkyl group represented by R₂ may be monocyclic or polycyclic and may have a substituent.

R₂ is preferably an alkyl group, more preferably an alkyl group having 1 to 10 carbon atoms, and even more preferably an alkyl group having 1 to 5 carbon atoms. Examples thereof include a methyl group, an ethyl group, and the like.

R represents an atomic group necessary for forming an alicyclic structure together with carbon atoms. The alicyclic structure that R forms together with the carbon atoms is preferably a monocyclic alicyclic structure which preferably has 3 to 7 carbon atoms and more preferably has 5 or 6 carbon atoms.

R₃ is preferably a hydrogen atom or a methyl group, and more preferably a methyl group.

The alkyl group represented by R₄, R₅, and R₆ may be linear or branched and may have a substituent. As the alkyl group, an alkyl group having 1 to 4 carbon atoms such as a methyl group, an ethyl group, an n-propyl group, an isopropyl group, an n-butyl group, an isobutyl group, or a t-butyl group is preferable.

The cycloalkyl group represented by R₄, R₅, and R₆ may be monocyclic or polycyclic and may have a substituent. As the cycloalkyl group, a monocyclic cycloalkyl group (monocyclic cycloalkyl group having 5 to 8 carbon atoms) such as a cyclopentyl group or a cyclohexyl group and a polycyclic cycloalkyl group (preferably a polycyclic cycloalkyl group having 7 to 12 carbon atoms) such as a norbornyl group, a tetracyclodecanyl group, a tetracyclododecanyl group, or an adamantyl group are preferable.

Examples of substituents that the aforementioned groups can each have include the same groups as described above as substituents that the groups in General Formula (AI) can each have. As the substituent, a group which contains at least one kind of atom selected from a fluorine atom and a silicon atom is preferable.

The resin (a) may be a resin containing, as the repeating unit represented by General Formula (A1), the repeating unit represented by General Formula (I) and the repeating unit represented by General Formula (II).

In another aspect, the resin (a) may be a resin containing, as the repeating unit represented by General Formula (AI), at least two kinds of repeating units represented by General Formula (I). In a case where the resin (a) contains two or more kinds of repeating units represented by General Formula (I), it is preferable that the resin (a) contains both of the repeating unit in which the alicyclic structure that R forms together with carbon atoms is a monocyclic alicyclic structure and the repeating unit in which the alicyclic structure that R forms together with carbon atoms is a polycyclic alicyclic structure. The number of carbon atoms in the monocyclic alicyclic structure is preferably 5 to 8, more preferably 5 or 6, and particularly preferably 5. As the polycyclic alicyclic structure, a norbornyl group, a tetracyclodecanyl group, a tetracyclododecanyl group, and an adamantyl group are preferable.

One kind of repeating unit having an acid decomposable group may be contained in the resin (a), or two or more kinds thereof may be contained in the resin (a) in combination. In a case where two or more kinds of the repeating units are used in combination, the repeating units are preferably combined as below, for example. In the following formulae, R each independently represents a hydrogen atom or a methyl group.

The repeating unit represented by General Formula (I) and the repeating unit represented by General Formula (II) that are used by being combined as below also each show preferred specific examples thereof.

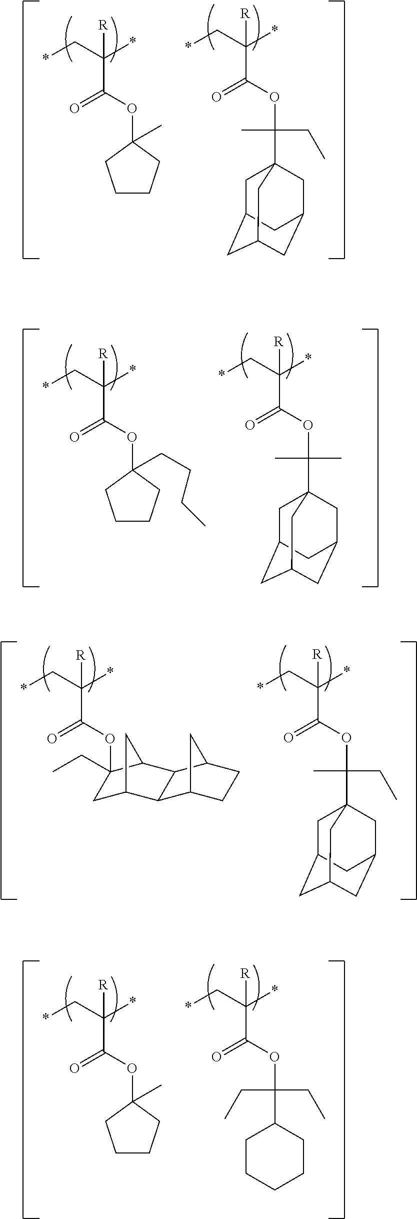

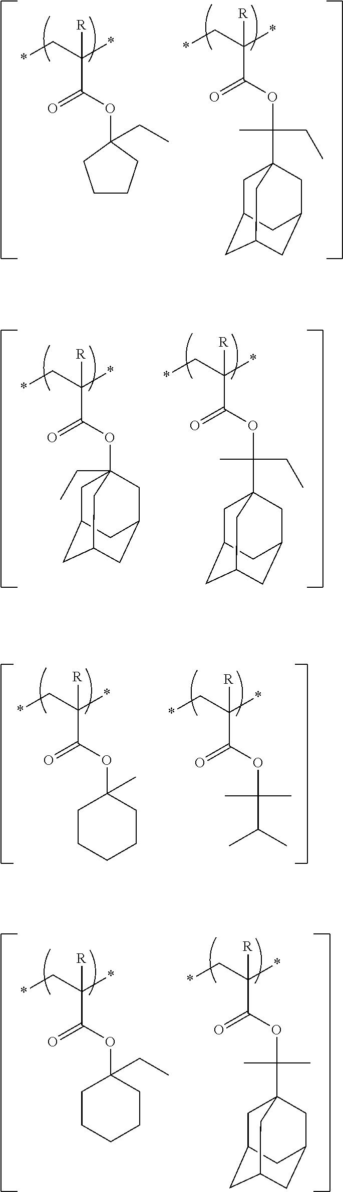

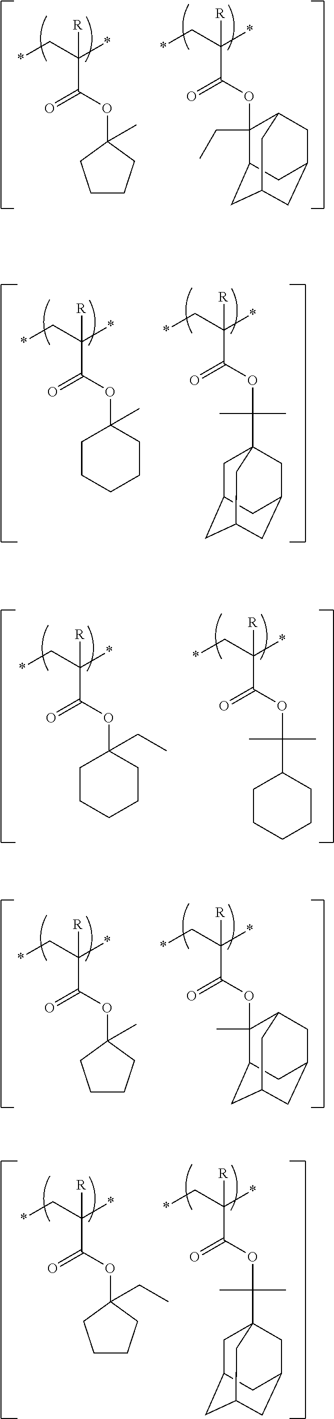

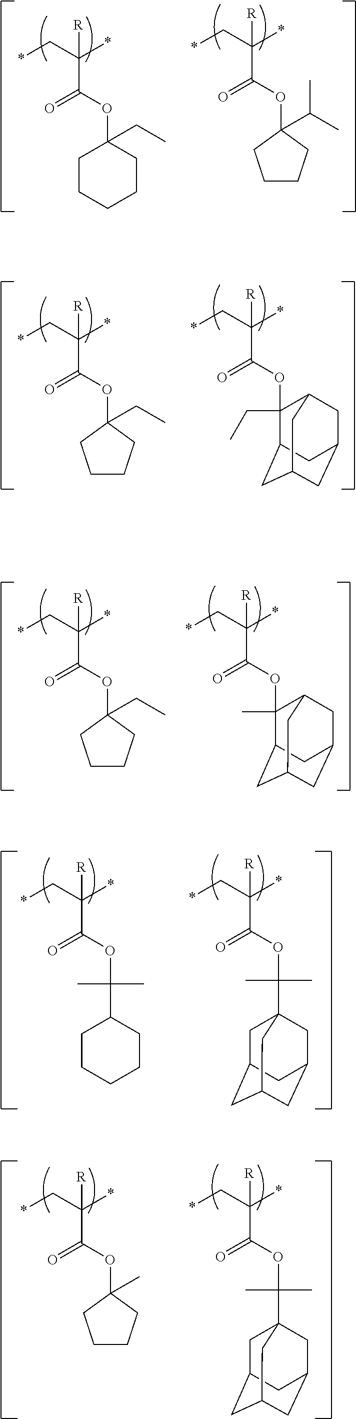

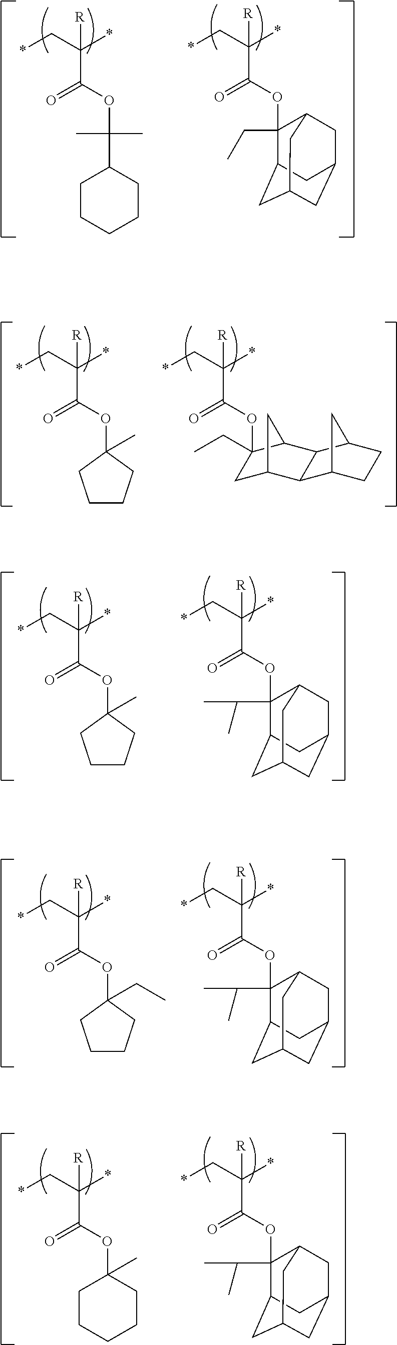

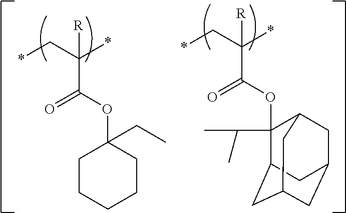

The repeating unit having an acid decomposable group is preferably further substituted with a group which contains at least one kind of atom selected from a fluorine atom and a silicon atom which will be described later.

The present invention has a hardcoat layer formed of the composition for forming a hardcoat layer containing the resin (a). In a state where a support is coated with the composition for forming a hardcoat layer, fluorine atoms or silicon atoms are localized on the surface of the hardcoat layer, and an excellent surface condition is exhibited. Therefore, it is possible to prevent air blow unevenness at the time of coating and drying of the hardcoat layer.

In a case where a composition for forming a hardcoat layer containing (b) acid generator, which will be described later, is used, the hardcoat layer is irradiated with ionizing radiation such as ultraviolet rays (UV) when being hardened, and in a case where a composition for forming a hardcoat layer not containing (b) is used, an acid treatment (for example, an acid treatment for neutralization performed in a case where the hardcoat layer is hardened and then a saponification treatment is performed on the film) is carried out. In this way, the acid decomposable group is decomposed, and hence polarity changes. As a result, the surface of the hardcoat layer can be hydrophilized, and the laminating properties of other layers laminated on the hardcoat layer can be improved.

Therefore, in a case where the repeating unit having an acid decomposable group is substituted with a group which contains at least one kind of atom selected from a fluorine atom and a silicon atom, on a single side chain, the position of the acid decomposable group is preferably closer to a main chain than a fluorine atom or a silicon atom. That is, the group performing elimination by using an acid is preferably a group containing a group which contains at least one kind of atom selected from a fluorine atom and a silicon atom.

Specifically, it is preferable that a hydrogen atom in the alkyl group or the cycloalkyl group represented by Rx₁ to Rx₃ in General Formula (AI) is substituted with a group containing at least one kind of atom selected from a fluorine atom and a silicon atom. It is more preferable that a hydrogen atom in the atomic group represented by R₃₃ in General Formula (3), a hydrogen atom in the atomic group represented by R in General Formula (I), or a hydrogen atom in the alkyl group or the cycloalkyl group represented by R₄ to R₆ in General Formula (II) is substituted with a group containing at least one kind of atom selected from a fluorine atom and a silicon atom.

In a case where the hardcoat film of the present invention is irradiated with ionizing radiation such as UV or subjected to the acid treatment, a hydrophobic group in the resin (a) is decomposed and becomes a hydrophilic group, and hence the hydrophilicity increases. Therefore, the contact angle of the surface of the hardcoat layer with respect to water is reduced, and the surface becomes hydrophilic. Specifically, in a case where the hardcoat film is irradiated with ionizing radiation (preferably irradiated with ultraviolet rays at 10 mJ/cm² to 1,000 mJ/cm²) or subjected to the acid treatment (preferably immersed in an aqueous sulfuric acid solution of 0.01 to 1 mol/L), the contact angle between the hardcoat layer and water is preferably equal to or less than 75°, more preferably equal to or less than 60°, and most preferably equal to or less than 50°. The lower limit of the contact angle is preferably equal to or more than 10°.

Herein, both the hardcoat film in which the acid decomposable group has not yet been decomposed by an acid from the acid generator or by the acid treatment and the hardcoat film in which the acid decomposable group has been decomposed are included in the present invention.

[Group Containing at Least One Kind of Atom Selected from Fluorine Atom and Silicon Atom]

The resin (a) has a group containing at least one kind of atom selected from a fluorine atom and a silicon atom.

As a group containing a fluorine atom, a structure is preferable which has an alkyl group having a fluorine atom, a cycloalkyl group having a fluorine atom, or an aryl group having a fluorine atom.

The alkyl group (preferably having 1 to 10 carbon atoms and more preferably having 1 to 4 carbon atoms) having a fluorine atom is a linear or branched alkyl group in which at least one hydrogen atom is substituted with a fluorine atom, and may have other substituents.

The cycloalkyl group having a fluorine atom is a monocyclic or polycyclic cycloalkyl group in which at least one hydrogen atom is substituted with a fluorine atom, and may have other substituents.

Examples of the aryl group having a fluorine atom include an aryl group such as a phenyl group or a naphthyl group in which at least one hydrogen atom is substituted with a fluorine atom, and the aryl group may have other substituents.

Examples of the alkyl group having a fluorine atom, the cycloalkyl group having a fluorine atom, or the aryl group having a fluorine atom preferably include a group represented by any one of General Formulae (F2) to (F4), but the present invention is not limited thereto.

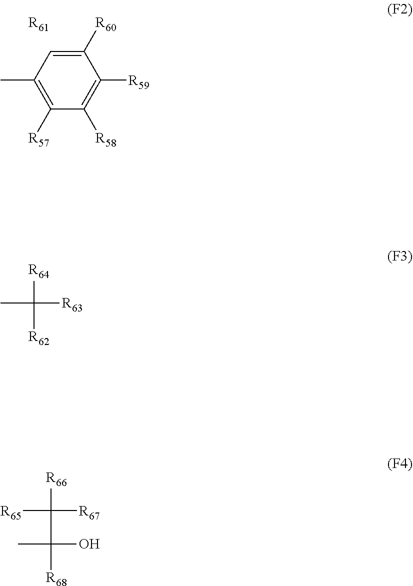

In General Formulae (F2) to (F4), R₅₇ to R₆₈ each independently represent a hydrogen atom, a fluorine atom, or an alkyl group (linear or branched). R₆₂ and R₆₃ may form a cycloalkyl group by being bonded to each other. Here, at least one of R₅₇, R₅₈, R₅₉, R₆₀, or R₆₁, at least one of R₆₂, R₆₃, or R₆₄, and at least one of R₆₅, R₆₆, R₆₇, or R₆₈ represent a fluorine atom or an alkyl group (preferably having 1 to 5 carbon atoms) in which at least one hydrogen atom is substituted with a fluorine atom.

It is preferable that all of R₅₇ to R₆₁ and R₆₅ to R₆₇ represent a fluorine atom. Furthermore, it is preferable that all of R₆₂ to R₆₄ represent a fluorine atom or represent a fluorine atom or a perfluoroalkyl group having 1 to 5 carbon atoms.

R₆₈ is preferably a fluoroalkyl group (preferably having 1 to 4 carbon atoms) and more preferably a perfluoroalkyl group having 1 to 4 carbon atoms. R₆₂ and R₆₃ may form a ring by being linked to each other.

Specific examples of the group represented by General Formula (F2) include a p-fluorophenyl group, a pentafluorophenyl group, a 3,5-di(trifluoromethyl)phenyl group, and the like.

Specific examples of the group represented by General Formula (F3) include a trifluoromethyl group, a pentafluoropropyl group, a pentafluoroethyl group, a heptafluorobutyl group, a hexafluoroisopropyl group, a heptafluoroisopropyl group, a hexafluoro(2-methyl)isopropyl group, a nonafluorobutyl group, an octafluoroisobutyl group, a nonafluorohexyl group, a nonafluoro-t-butyl group, a perfluoroisopentyl group, a perfluorooctyl group, a perfluoro(trimethyl)hexyl group, a 2,2,3,3-tetrafluorocyclobutyl group, a perfluorocyclohexyl group, —(CF₂)₆H, and the like. Among these, a trifluoromethyl group and a pentafluoropropyl group are preferable.

Specific examples of the group represented by General Formula (F4) include —C(CF₃)₂OH, —C(C₂F₅)₂OH, —C(CF₃)(CH₃)OH, —CH(CF₃)OH, and the like. Among these, —C(CF₃)₂OH is preferable.

The partial structure containing fluorine may be directly bonded or bonded through one group or a combination of two or more groups selected from the group consisting of an alkylene group, a phenylene group, an ether group, a thioether group, a carbonyl group, an ester group, an amide group, a urethane group, and a ureylene group.

As the partial structure (group) having a silicon atom, an alkylsilyl group (preferably a trialkylsilyl group) or a group having a cyclic siloxane structure is preferable.

Specific examples of the alkylsilyl group or the group having a cyclic siloxane structure include the groups represented by General Formulae (CS-1) to (CS-3), and the like.

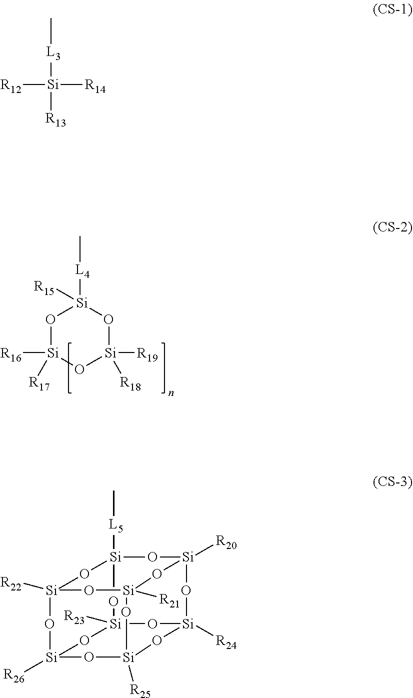

In General Formulae (CS-1) to (CS-3), R₁₂ to R₂₆ each independently represent a linear or branched alkyl group (preferably having 1 to 20 carbon atoms) or a cycloalkyl group (preferably having 3 to 20 carbon atoms).

L₃ to L₅ each independently represent a single bond or a divalent linking group. Examples of the divalent linking group include one group or a combination of two or more groups selected from the group consisting of an alkylene group, a phenylene group, an ether group, a thioether group, a carbonyl group, an ester group, an amide group, a urethane group, or a ureylene group.

n represents an integer of 1 to 5.

The group containing at least one kind of atom selected from a fluorine atom and a silicon atom may be contained in the aforementioned repeating unit containing an acid decomposable group or in other repeating units not containing an acid decomposable group. However, the group is preferably contained in the repeating unit containing an acid decomposable group. It is more preferable that the group performing elimination by using an acid is a group which contains the group containing at least one kind of atom selected from a fluorine atom and a silicon atom.

In a case where the resin (a) has a fluorine atom, the content rate of the fluorine atom is preferably 5% to 80% by mass and more preferably 10%/o to 80% by mass with respect to the molecular weight of the resin (a). Furthermore, the content of the repeating unit containing a fluorine atom is preferably 10 to 100 mol % and more preferably 30 to 100 mol % with respect to all the repeating units in the resin (a).

In a case where the resin (a) has a silicon atom, the content rate of the silicon atom is preferably 2% to 50% by mass and more preferably 2% to 30% by mass with respect to the molecular weight of the resin (a). Furthermore, the content of the repeating unit containing a silicon atom is preferably 10 to 90 mol % and more preferably 20 to 80 mol % with respect to all the repeating units in the resin (a).

The resin (a) may further have other repeating units. Examples of preferred aspects of other repeating units include a repeating unit (cy) which is stable against an acid and is poorly soluble or insoluble in an alkaline solution.

Regarding the repeating unit (cy), being poorly soluble or insoluble in an alkaline solution means that (cy) does not contain an alkali-soluble group or a group (for example, an acid decomposable group or a polarity changing group) generating an alkali-soluble group by the action of an acid or alkaline solution.

The repeating unit (cy) preferably has an alicyclic hydrocarbon structure without a polar group.

Preferred aspects of the repeating unit (cy) will be shown below. The repeating unit (cy) is preferably a repeating unit represented by General Formula (CIII).

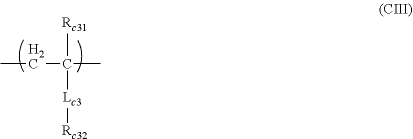

In General Formula (CIII), R_{C31} represents a hydrogen atom, an alkyl group which may be substituted with a fluorine atom, a cyano group, or a —CH₂O-Rac₂ group. In the formula, Rac₂ represents a hydrogen atom, an alkyl group, or an acyl group. R_{C31} is preferably a hydrogen atom, a methyl group, a hydroxymethyl group, or a trifluoromethyl group, and particularly preferably a hydrogen atom or a methyl group.

R_{C32} represents a group having an alkyl group, a cycloalkyl group, an alkenyl group, or a cycloalkenyl group. These groups may be substituted with a fluorine atom or a silicon atom.

L_{C3} represents a single bond or a divalent linking group.

The alkyl group represented by R_{C32} in General Formula (CIII) is preferably a linear or branched alkyl group having 3 to 20 carbon atoms.

The cycloalkyl group is preferably a cycloalkyl group having 3 to 20 carbon atoms.

The alkenyl group is preferably an alkenyl group having 3 to 20 carbon atoms.

The cycloalkenyl group is preferably a cycloalkenyl group having 3 to 20 carbon atoms.

R_{C32} is preferably an unsubstituted alkyl group or an alkyl group substituted with a fluorine atom.

The divalent linking group represented by L_{C3} is preferably an ester group, an alkylene group (preferably having 1 to 5 carbon atoms), an oxy group, a phenylene group, or an ester bond (group represented by —COO—).

As the repeating unit (cy), a repeating unit represented by General Formula (C4) or (C5) is preferable.

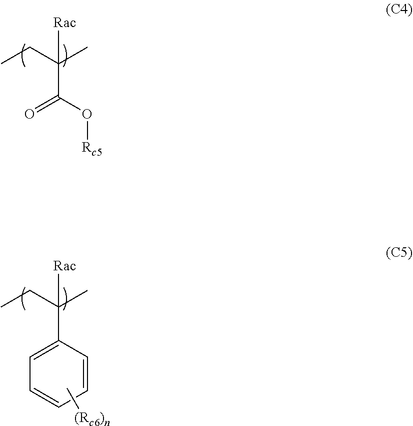

In General Formula (C4). R_{C5} has at least one cyclic structure and represents a hydrocarbon group having neither a hydroxyl group nor a cyano group.

Rac represents a hydrogen atom, an alkyl group which may be substituted with a fluorine atom, a cyano group, or a —CH₂—O-Rac₂ group. In the formula, Rac₂ represents a hydrogen atom, an alkyl group, or an acyl group. Rac is preferably a hydrogen atom, a methyl group, a hydroxymethyl group, or a trifluoromethyl group, and particularly preferably a hydrogen atom or a methyl group.

The cyclic structure that R_{C5} has includes a monocyclic hydrocarbon group and a polycyclic hydrocarbon group. Examples of the monocyclic hydrocarbon group include a cycloalkyl group having 3 to 12 carbon atoms and a cycloalkenyl group having 3 to 12 carbon atoms. As the monocyclic hydrocarbon group, a monocyclic hydrocarbon group having 3 to 7 carbon atoms is preferable.

The polycyclic hydrocarbon group includes a ring-aggregated hydrocarbon group and a crosslinked cyclic hydrocarbon group. Examples of the crosslinked cyclic hydrocarbon ring include a bicyclic hydrocarbon ring, a tricyclic hydrocarbon ring, a tetracyclic hydrocarbon ring, and the like. The crosslinked cyclic hydrocarbon ring also includes a condensed hydrocarbon ring (for example, a condensed ring in which a plurality of 5- to 8-membered cycloalkane rings are condensed with each other). Examples of preferred crosslinked cyclic hydrocarbon rings include a norbornyl group and an adamantyl group.

These alicyclic hydrocarbon groups may have a substituent, and examples of preferred substituents include a halogen atom, an alkyl group, a hydroxyl group protected with a protecting group, an amino group protected with a protecting group, and the like. Examples of preferred halogen atoms include bromine, chlorine, and fluorine atoms, and examples of preferred alkyl groups include methyl, ethyl, butyl, and t-butyl groups. The aforementioned alkyl group may further have a substituent, and examples of the substituent that the alkyl group may further have include a halogen atom, an alkyl group, a hydroxyl group protected with a protecting group, and an amino group protected with a protecting group.

Examples of the protecting group include an alkyl group, a cycloalkyl group, an aralkyl group, a substituted methyl group, a substituted ethyl group, an alkoxycarbonyl group, and an aralkyloxycarbonyl group. Examples of preferred alkyl groups include an alkyl group having 1 to 4 carbon atoms. Examples of preferred substituted methyl groups include methocymethyl, methoxythiomethyl, benzyloxymethyl, t-butoxymethyl, and 2-methoxyethoxymethyl groups. Examples of preferred substituted ethyl groups include 1-ethoxyethyl and 1-methyl-1-methoxyethyl. Examples of preferred acyl groups include an aliphatic acyl group having 1 to 6 carbon atoms such as formyl, acetyl, propionyl, butyryl, isobutyryl, valeryl, and pivaloyl groups. Examples of the alkoxycarbonyl group include an alkoxycarbonyl group having 1 to 4 carbon atoms, and the like.

In General Formula (CS), R_{C6} represents an alkyl group, a cycloalkyl group, an alkenyl group, a cycloalkenyl group, an alkoxycarbonyl group, or an alkylcarbonyloxy group. These groups may be substituted with a fluorine atom or a silicon atom.

The alkyl group represented by R_{C6} is preferably a linear or branched alkyl group having 1 to 20 carbon atoms. The cycloalkyl group is preferably a cycloalkyl group having 3 to 20 carbon atoms.

The alkenyl group is preferably an alkenyl group having 3 to 20 carbon atoms.

The cycloalkenyl group is preferably a cycloalkenyl group having 3 to 20 carbon atoms.

The alkoxycarbonyl group is preferably an alkoxycarbonyl group having 2 to 20 carbon atoms.

The alkylcarbonyloxy group is preferably an alkylcarbonyloxy group having 2 to 20 carbon atoms.

n represents an integer of 0 to 5. In a case where n is equal to or greater than 2, a plurality of R_{C6}'s may be the same as or different from each other.

R_{C6} is preferably an unsubstituted alkyl group or an alkyl group substituted with a fluorine atom, and particularly preferably a trifluoromethyl group or a t-butyl group.

As (cy), a repeating unit represented by General Formula (CII-AB) is also preferable.

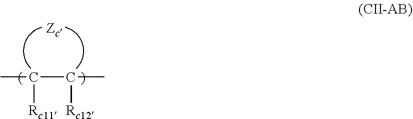

In Formula (CII-AB), R_{C11}′ and R_{C12}′ each independently represent a hydrogen atom, a cyano group, a halogen atom, or an alkyl group.

Z_{C}′ contains two carbon atoms (C—C) bonded to each other and represents an atomic group for forming an alicyclic structure.

General Formula (CII-AB) is more preferably General Formula (CII-AB1) or General Formula (CII-AB2).

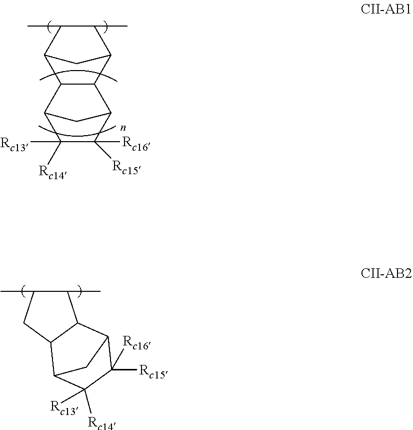

In Formulae (CII-AB1) and (CII-AB2), R_{C13}′ to R_{C16}′ each independently represent a hydrogen atom, a halogen atom, an alkyl group, or a cycloalkyl group.

At least two among R_{C13}′ to R_{C16}′ may form a ring by being bonded to each other.

n represents 0 or 1.

Specific examples of (cy) will be shown below, but the present invention is not limited thereto. In the following formulae, Ra represents H, CH₃, CH₂OH, CF₃, or CN.

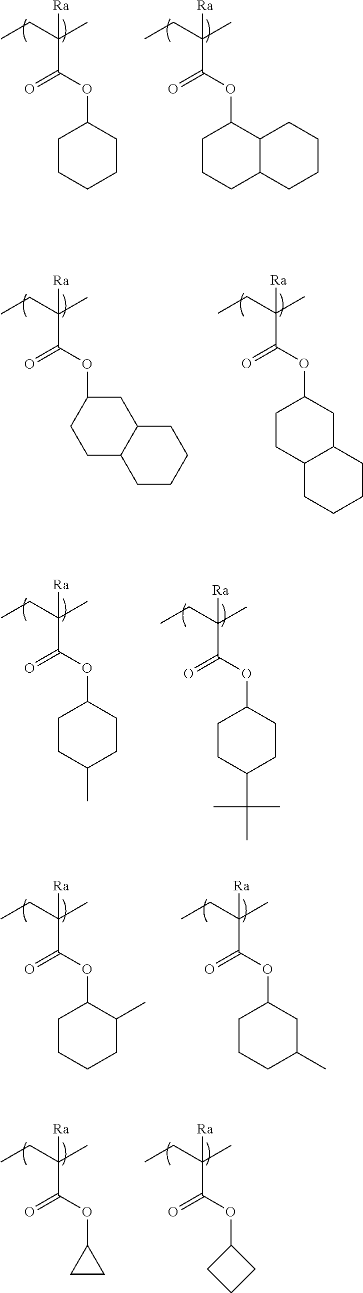

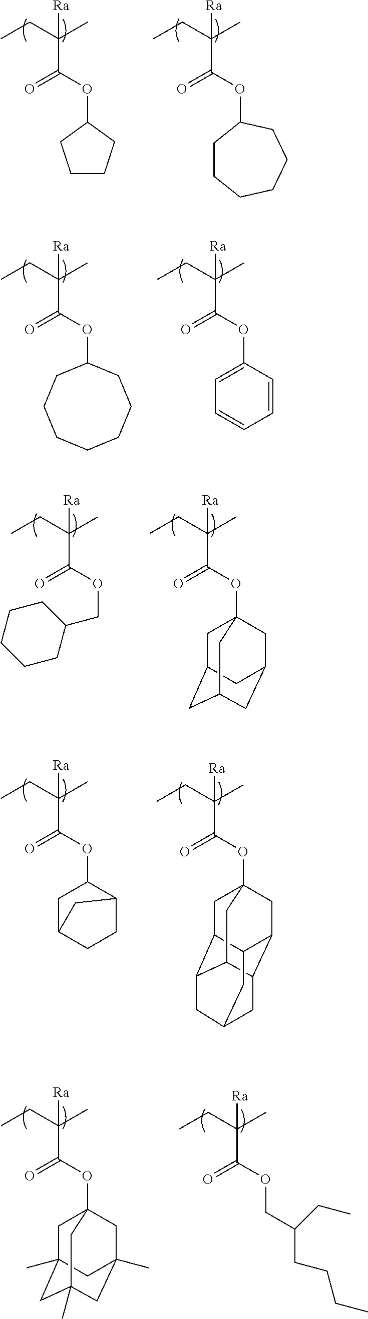

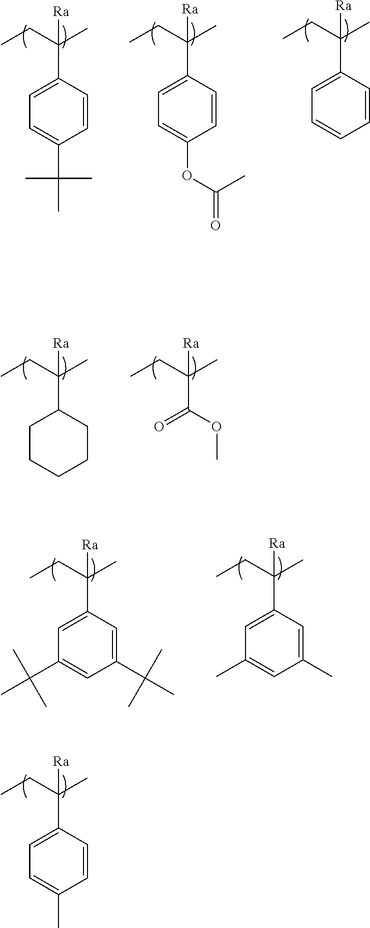

The content rate of the repeating unit represented by (cy) is preferably 5 to 40 mol % and more preferably 5 to 30 mol % with respect to all the repeating units in the resin (a). The resin (a) may have a plurality of repeating units represented by (cy).

The resin (a) used in the composition of the present invention may have various repeating structural units in addition to the aforementioned repeating structural units.

Examples of such repeating structural units include repeating structural units corresponding to the following monomers, but the present invention is not limited thereto.

Examples of such monomers include a compound having one addition polymerizable unsaturated bond selected from acrylic acid esters, methacrylic acid esters, acrylamides, methacrylamides, an allyl compound, vinyl ethers, and vinyl esters, and the like.

In addition, addition polymerizable unsaturated compounds which can be copolymerized with the monomers corresponding to the various aforementioned repeating structural units may be copolymerized.

The weight-average molecular weight of the resin (a) expressed in terms of standard polystyrene is preferably 1,000 to 100,000, more preferably 1,000 to 50,000, and even more preferably 2,000 to 15,000. The weight-average molecular weight in the present invention refers to a weight-average molecular weight measured by gel permeation chromatography (GPC) and expressed in terms of polystyrene. Specifically, for example, the weight-average molecular weight is measured under the following condition.

GPC device: HLC-8120 (manufactured by Tosoh Corporation)

Column: TSK gelMultipore HXL-M (manufactured by Tosoh Corporation, 7.8 mm ID (inner diameter)×30.0 cm)

Eluent: tetrahydrofuran (THF)

The content rate of the resin (a) in the total solid content of the composition for forming a hardcoat layer can be appropriately adjusted. Based on the total solid content of the composition for forming a hardcoat layer, the content rate of the resin (a) is preferably 0.0001% to 1% by mass, more preferably 0.0005% to 0.1% by mass, and even more preferably 0.001% to 0.05% by mass.

The resin (a) can be synthesized and purified according to a common method. Although it goes without saying that the resin (a) contains only a small amount of impurities such as metals, the content of a residual monomer or oligomer component in the resin (a) is preferably 0% to 10% by mass, more preferably 0% to 5% by mass, and even more preferably 0% to 1% by mass. In a case where the content of a residual monomer or oligomer component is within the above range, a resist is obtained which does not contain a foreign substance or does not experience a change in sensitivity or the like over time. The molecular weight distribution (Mw/Mn, referred to as dispersity) of the resin (a) is preferably within a range of 1 to 3, more preferably within a range of 1 to 2, even more preferably within a range of 1 to 1.8, and most preferably within a range of 1 to 1.5.

As the resin (a), various commercially available products can be used. Alternatively, the resin (a) can be synthesized according to a common method (for example, radical polymerization).

Specific examples of the resin (a) will be shown below.

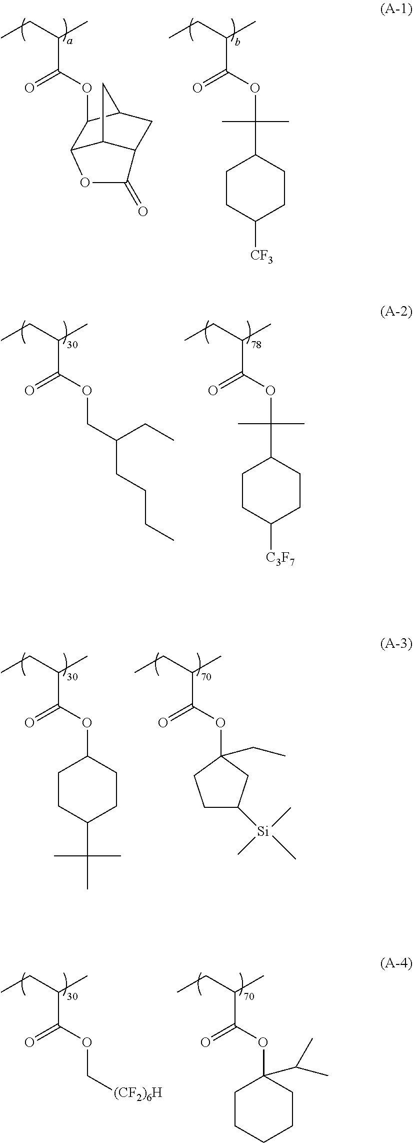

Resin having structure represented by (A-1): ab=50:50 (molar ratio), Mw=7,000 MwMn=1.4
Resin having structure represented by (A-1): a:b=30:70 (molar ratio), Mw=9,000, Mw/Mn=1.4
Resin having structure represented by (A-1): a:b=10:90 (molar ratio), Mw=6,000, Mw/Mn=1.3
Resin having structure represented by (A-2): Mw=10,000, Mw/Mn=1.5
Resin having structure represented by (A-3): Mw=8,000, Mw/Mn=1.4
Resin having structure represented by (A-4): Mw=12,000, Mw/Mn=1.5

One kind of resin (a) may be used singly, or two or more kinds thereof may be used in combination.

<<(b) Acid Generator>>

In an aspect, the composition for forming a hardcoat layer of the present invention contains (b) acid generator (referred to as “(b) component” as well).

The acid generator is not particularly limited, and preferred examples thereof include compounds represented by General Formulae (ZI′), (ZII′), and (ZIII′).

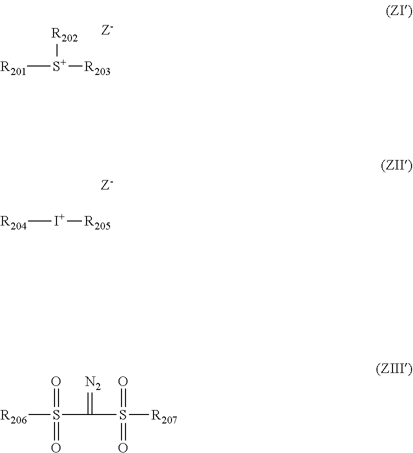

In General Formula (ZI′), R₂₀₁, R₂₀₂, and R₂₀₃ each independently represent an organic group.

The number of carbon atoms in the organic group represented by R₂₀₁, R₂₀₂, and R₂₀₃ is generally 1 to 30 and preferably 1 to 20.

Two among R₂₀₁ to R₂₀₃ may form a ring by being bonded to each other, and the ring may contain an oxygen atom, a sulfur atom, an ester bond, an amide bond, or a carbonyl group. Examples of the group formed by the bonding between two among R₂₀₁ to R₂₀₃ include an alkylene group (for example, a butylene group or a pentylene group).

Examples of the organic group represented by R₂₀₁, R₂₀₂, and R₂₀₃ include the group corresponding to a compound (ZI′-1) which will be described later.

The acid generator may be a compound having a plurality of structures represented by General Formula (ZI′). For example, the acid generator may be a compound having a structure in which at least one of R₂₀₁, R₂₀₂, or R₂₀₃ in the compound represented by General Formula (ZI′) is bonded to at least one of R₂₀₁, R₂₀₂, or R₂₀₃ in another compound represented by General Formula (ZI′) through a single bond or a divalent linking group.

Z⁻ represents a non-nucleophilic anion (anion that is markedly less capable of causing a nucleophilic reaction).

Examples of Z⁻ include a sulfonate anion (an aliphatic sulfonic anion, an aromatic sulfonate anion, a camphorsulfonate anion, and the like), a carboxylate anion (an aliphatic carboxylate anion, an aromatic carboxylate anion, an aralkylcarboyxlate anion, and the like), a sulfonylimide anion, a bis(alkvlsulfonyl)imide anion, a tris(alkylsulfonyl)methide anion, and the like.

The aliphatic moiety in the aliphatic sulfonate anion and the aliphatic carboxylate anion may be an alkyl group or a cycloalkyl group. Examples of the aliphatic moiety preferably include a linear or branched alkyl group having 1 to 30 carbon atoms and a cycloalkyl group having 3 to 30 carbon atoms.

Examples of the aromatic group in the aromatic sulfonate anion and the aromatic carboxylate anion preferably include an aryl group having 6 to 14 carbon atoms such as a phenyl group, a tolyl group, and a naphthyl group, and the like.

The alkyl group, the cycloalkyl group, and the aryl group exemplified above may have a substituent. Examples of the substituent include a nitro group, a halogen atom such as a fluorine atom, a carboxyl group, a hydroxyl group, an amino group, a cyano group, an alkoxy group (preferably having 1 to 15 carbon atoms), a cycloalkyl group (preferably having 3 to 15 carbon atoms), an aryl group (preferably having 6 to 14 carbon atoms), an alkoxycarbonyl group (preferably having 2 to 7 carbon atoms), an acyl group (preferably having 2 to 12 carbon atoms), an alkoxycarbonyloxy group (preferably having 2 to 7 carbon atoms), an alkylthio group (preferably having 1 to 15 carbon atoms), an alkylsulfonyl group (preferably having 1 to 15 carbon atoms), an alkyliminosulfonyl group (preferably having 2 to 15 carbon atoms), an aryloxysulfonyl group (preferably having 6 to 20 carbon atoms), an alkylaryloxysulfonyl group (preferably having 7 to 20 carbon atoms), a cycloalkylaryloxysulfonyl group (preferably having 10 to 20 carbon atoms), an alkyloxyalkyloxy group (preferably having 5 to 20 carbon atoms), a cycloalkylalkyloxyalkyloxy group (preferably having 8 to 20 carbon atoms), and the like. The aryl group and the ring structure that each of these groups have can further have an alkyl group (preferably having 1 to 15 carbon atoms) as a substituent, for example.

The aralkyl group in the aralkylcarboxylate anion is preferably an aralkyl group having 7 to 12 carbon atoms, and examples thereof include a benzyl group, a phenethyl group, a naphthylmethyl group, a naphthylethyl group, a naphthylbutyl group, and the like.

Examples of the sulfonylimide anion include saccharine anion.

The alkyl group in the bis(alkylsulfonyl)imide anion and the tris(alkylsulfonyl)methide anion is preferably an alkyl group having 1 to 5 carbon atoms.

Two alkyl groups in the bis(alkylsulfonyl)imide anion may form an alkylene group (preferably having 2 to 4 carbon atoms) by being linked to each other and may form a ring together with an imide group and two sulfonyl groups.

These alkyl groups and the alkylene group that two alkyl groups in bis(alkylsulfonyl)imide anion form by being linked to each other can have a substituent, and examples of the substituent include a halogen atom, an alkyl group substituted with a halogen atom, an alkoxy group, an alkylthio group, an alkyloxysulfonyl group, an aryloxysulfonyl group, a cycloalkyl aryloxysulfonyl group, and the like. Among these, a fluorine atom or an alkyl group substituted with a fluorine atom is preferable.

Examples of other anions represented by Z⁻ include phosphorus fluoride (for example, PF₆⁻), boron fluoride (for example, BF₄⁻), antimony fluoride (for example, SbF₆⁻), and the like.

As Z⁻, an aliphatic sulfonate anion in which at least the a-position of sulfonic acid is substituted with a fluorine atom, an aromatic sulfonate anion substituted with a fluorine atom or a group having a fluorine atom, a bis(alkylsulfonyl)imide anion in which an alkyl group is substituted with a fluorine atom, and a tris(alkylsulfonyl)methide anion in which an alkyl group is substituted with a fluorine atom are preferable. The non-nucleophilic anion is more preferably a perfluoro aliphatic sulfonate anion (more preferably having 4 to 8 carbon atoms) or a benzene sulfonate anion having a fluorine atom, and even more preferably a nonafluorobutane sulfonate anion, a perfluorooctane sulfonate anion, a pentafluorobenzene sulfonate anion, or a 3,5-bis(trifluoromethyl)benzene sulfonate anion.

From the viewpoint of acid strength, pKa of the generated acid is preferably equal to or less than −1, because then the sensitivity is improved.

Examples of a more preferred (ZI′) component include a compound (ZI′-1) described below.

The compound (ZI′-1) is an aryl sulfonium compound in which at least one of R₂₀₁, R₂₀₂, or R₂₀₃ in General Formula (ZI′) is an aryl group. That is, the compound (ZI′-1) is a compound having aryl sulfonium as a cation.

In the aryl sulfonium compound, all of R₂₀₁ to R₂₀₃ may be aryl groups, or some of R₂₀₁ to R₂₀₃ may be aryl groups and the rest may be an alkyl group or a cycloalkyl group. It is preferable that all of R₂₀₁ to R₂₀₃ are aryl groups.

Examples of the aryl sulfonium compound include a triaryl sulfonium compound, a diarylalkyl sulfonium compound, an aryldialkyl sulfonium compound, a diarylcycloalkyl sulfonium compound, and an aryldicycloalkyl sulfonium compound. Among these, a triaryl sulfonium compound is preferable.

The aryl group in the aryl sulfonium compound is preferably a phenyl group or a naphthyl group, and more preferably a phenyl group. The aryl group may be an aryl group having a heterocyclic structure containing an oxygen atom, a nitrogen atom, a sulfur atom, and the like. Examples of the heterocyclic structure include a pyrrole residue, a furan residue, a thiophene residue, an indole residue, a benzofuran residue, a benzothiophene residue, and the like. In a case where the aryl sulfonium compound has two or more aryl groups, the two or more aryl groups may be the same as or different from each other.

The alkyl group or the cycloalkyl group that the aryl sulfonium compound has as necessary is preferably a linear or branched alkyl group having 1 to 15 carbon atoms and a cycloalkyl group having 3 to 15 carbon atoms, and examples thereof include a methyl group, an ethyl group, a propyl group, an n-butyl group, a sec-butyl group, a t-butyl group, a cyclopropyl group, a cyclobutyl group, a cyclohexyl group, and the like.

The aryl group, the alkyl group, and the cycloalkyl group represented by R₂₀₁ to R₂₀₃ may have a substituent such as an alkyl group (for example, having 1 to 15 carbon atoms), a cycloalkyl group (for example, having 3 to 15 carbon atoms), an aryl group (for example, having 6 to 14 carbon atoms), an alkoxy group (for example, having 1 to 15 carbon atoms), a halogen atom, a hydroxyl group, or a phenylthio group. The substituent is preferably a linear or branched alkyl group having 1 to 12 carbon atoms, a cycloalkyl group having 3 to 12 carbon atoms, or a linear, branched, or cyclic alkoxy group having 1 to 12 carbon atoms, more preferably an alkyl group having 1 to 4 carbon atoms or an alkoxy group having 1 to 4 carbon atoms. The substituent may substitute any one of three groups including R₂₀₁, to R₂₀₃ or substitute all of them. In a case where R₂₀₁ to R₂₀₃ are aryl groups, the substituent may substitute the p-position of the aryl groups.

Next, General Formulae (ZII′) and (ZIII′) will be described.

In General Formulae (ZII′) and (ZIII′), R₂₀₄ to R₂₀₇ each independently represent an aryl group, an alkyl group, or a cycloalkyl group.

The aryl group, the alkyl group, and the cycloalkyl group represented by R₂₀₄ to R₂₀₇ are the same as the aryl group described as the aryl group, the alkyl group, and the cycloalkyl group represented by R₂₀₁ to R₂₀₃ in the compound (ZI′-1) described above.

The aryl group, the alkyl group, and the cycloalkyl group represented by R₂₀₄ to R₂₀₇ may have a substituent. Examples of the substituent include the substituents that the aryl group, the alkyl group, and the cycloalkyl group represented by R₂₀₁ to R₂₀₃ in the compound (ZI′-1) described above may have.

Z⁻ represents a non-nucleophilic anion, and examples thereof include the same anions as exemplified above for the non-nucleophilic anion represented by Z⁻ in General Formula (ZI′). Examples of the acid generator that can be used in the present invention also include compounds represented by General Formulae (ZIV′), (ZV′), and (ZVI′).

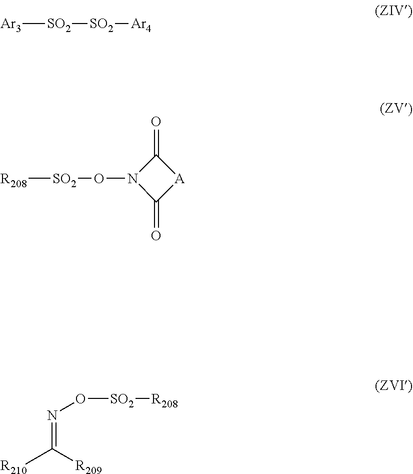

In General Formulae (ZIV′) to (ZVI′), Ar₃ and Ar₄ each independently represent an aryl group.

R₂₀₈, R₂₀₉, and R₂₁₀ each independently represent an alkyl group, a cycloalkyl group, or an aryl group.

A represents an alkylene group, an alkenylene group, or an arylene group.

Specific examples of the aryl group represented by Ar₃, Ar₄, R₂₀₈, R₂₀₉, and R₂₁₀ are the same as the specific examples of the aryl group represented by R₂₀₁, R₂₀₂, and R₂₀₃ in General Formula (ZI′-1) described above.

Specific examples of the alkyl group and the cycloalkyl group represented by R₂₀₈, R₂₀₉, and R₂₁₀ are the same as the specific examples of the alkyl group and the cycloalkyl group represented by R₂₀₁, R₂₀₂, and R₂₀₃ in General Formula (ZI′-1) described above, respectively.

Examples of the alkylene group represented by A include an alkylene group having 1 to 12 carbon atoms (for example, a methylene group, an ethylene group, a propylene group, an isopropylene group, a butylene group, and an isobutylene group). Examples of the alkenylene group represented by A include an alkenylene group having 2 to 12 carbon atoms (for example, an ethenylene group, a propenylene group, and a butenylene group). Examples of the arylene group represented by A include an arylene group having 6 to 10 carbon atoms (for example, a phenylene group, a tolylene group, and a naphthylene group).

As the acid generator that is particularly suitably used in the present invention, in view of the photosensitivity, the stability of the compound as a material, and the like, a diazonium salt, an iodonium salt, a sulfonium salt, and an iminium salt are preferable. Among these, from the viewpoint of light fastness, an iodonium salt is most preferable.

Specific examples of the acid generator that can be suitably used in the present invention include the amylated sulfonium salt described in paragraph “0035” in JP1997-268205A (JP-H09-268205A), the diaryl iodonium salt or the triaryl sulfonium salt described in paragraphs “0010” and “0011” in JP2000-71366A, the sulfonium salt of thiobenzoic acid S-phenyl ester described in paragraph “0017” in JP2001-288205A, the onium salt described in paragraphs “0030” to “0033” in JP2001-133696A, and the like.

Examples of other acid generators include the compounds described in paragraphs “0059” to “0062” in JP2002-29162A, such as an organic metal/organic halide, a photoacid generator having an o-nitrobenzyl type protecting group, and a compound (iminosulfonate or the like) generating sulfonic acid through photodecomposition.

Specifically, as an iodonium salt-based cationic polymerization initiator, it is possible to use compounds such as B2380 (manufactured by TOKYO CHEMICAL INDUSTRY CO., LTD.), BBI-102 (manufactured by Midori Kagaku Co., Ltd.), WPI-113 (manufactured by Wako Pure Chemical Industries, Ltd.), WPI-124 (manufactured by Wako Pure Chemical Industries, Ltd.), WPI-169 (manufactured by Wako Pure Chemical Industries, Ltd.), WPI-170 (manufactured by Wako Pure Chemical Industries, Ltd.), and DTBPI-PFBS (manufactured by Toyo Gosei Co., Ltd).

Specific examples of other acid generators that can be suitably used in the present invention will be shown below.

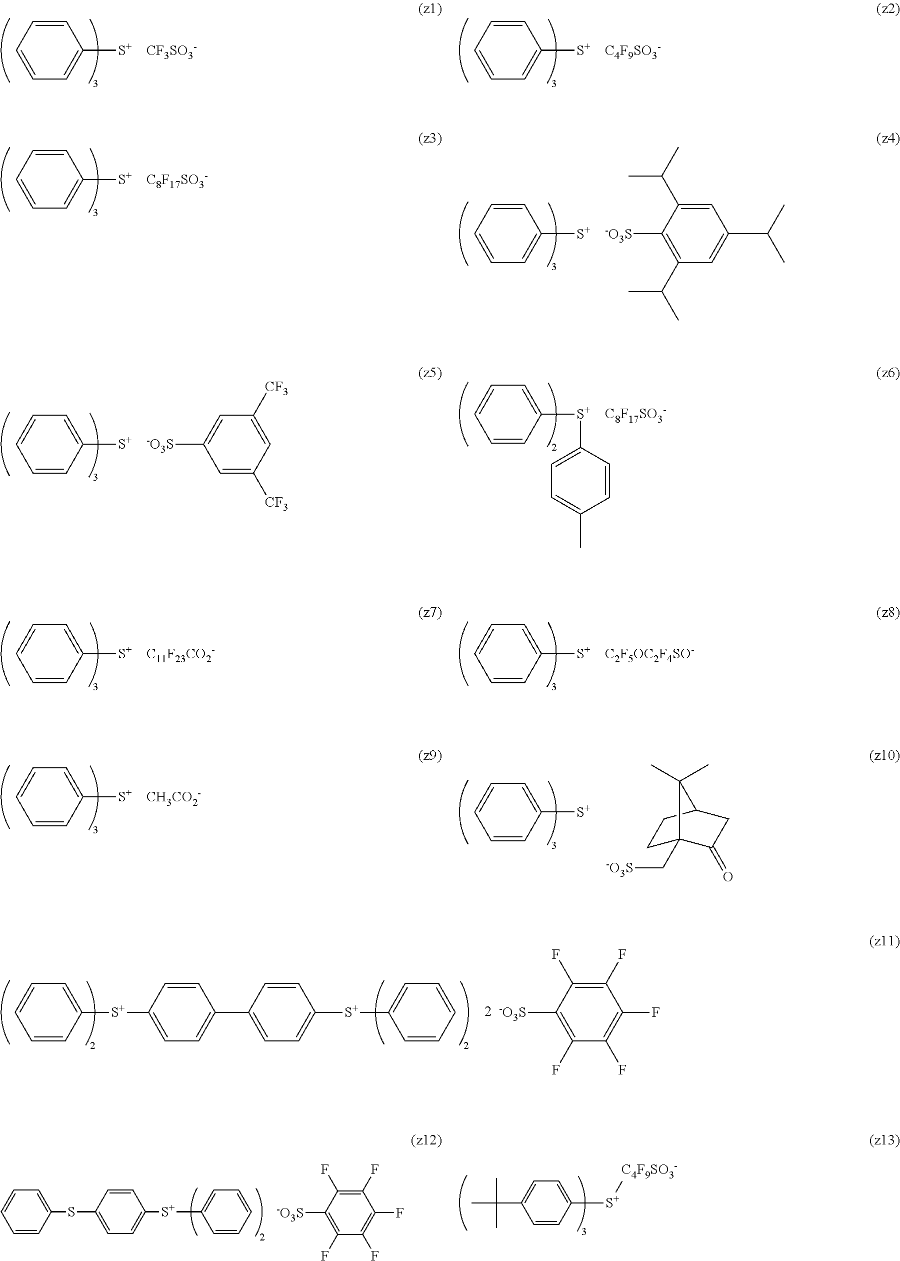

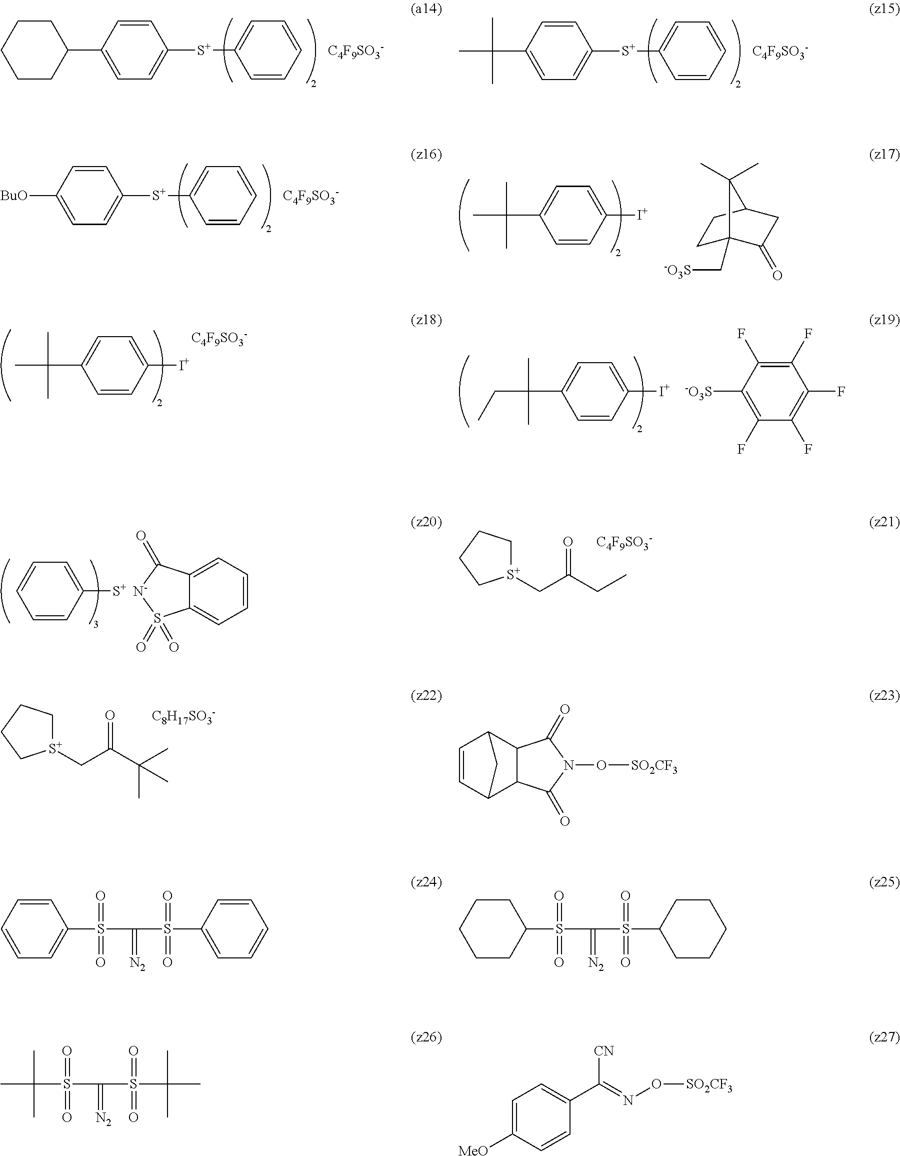

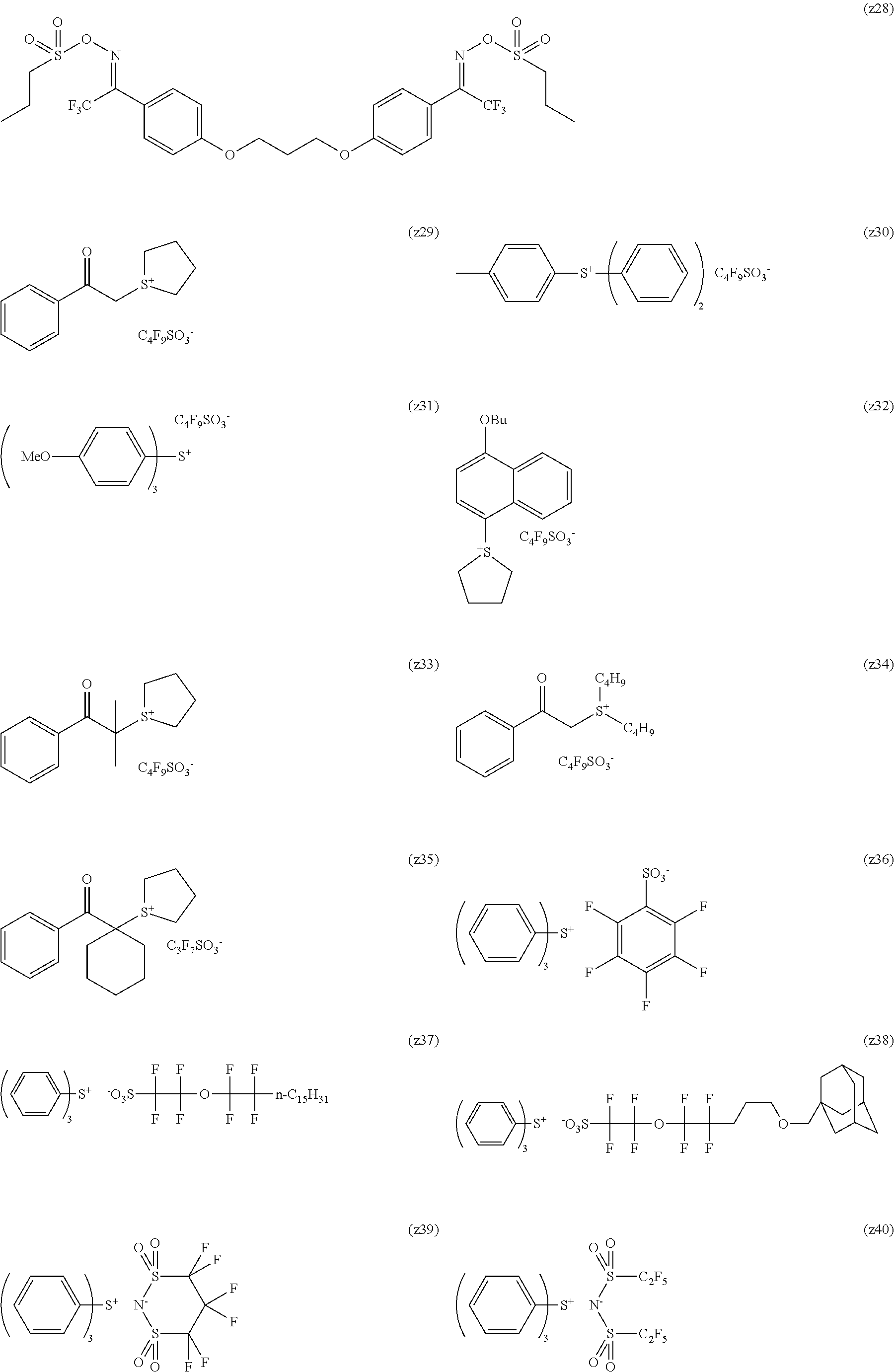

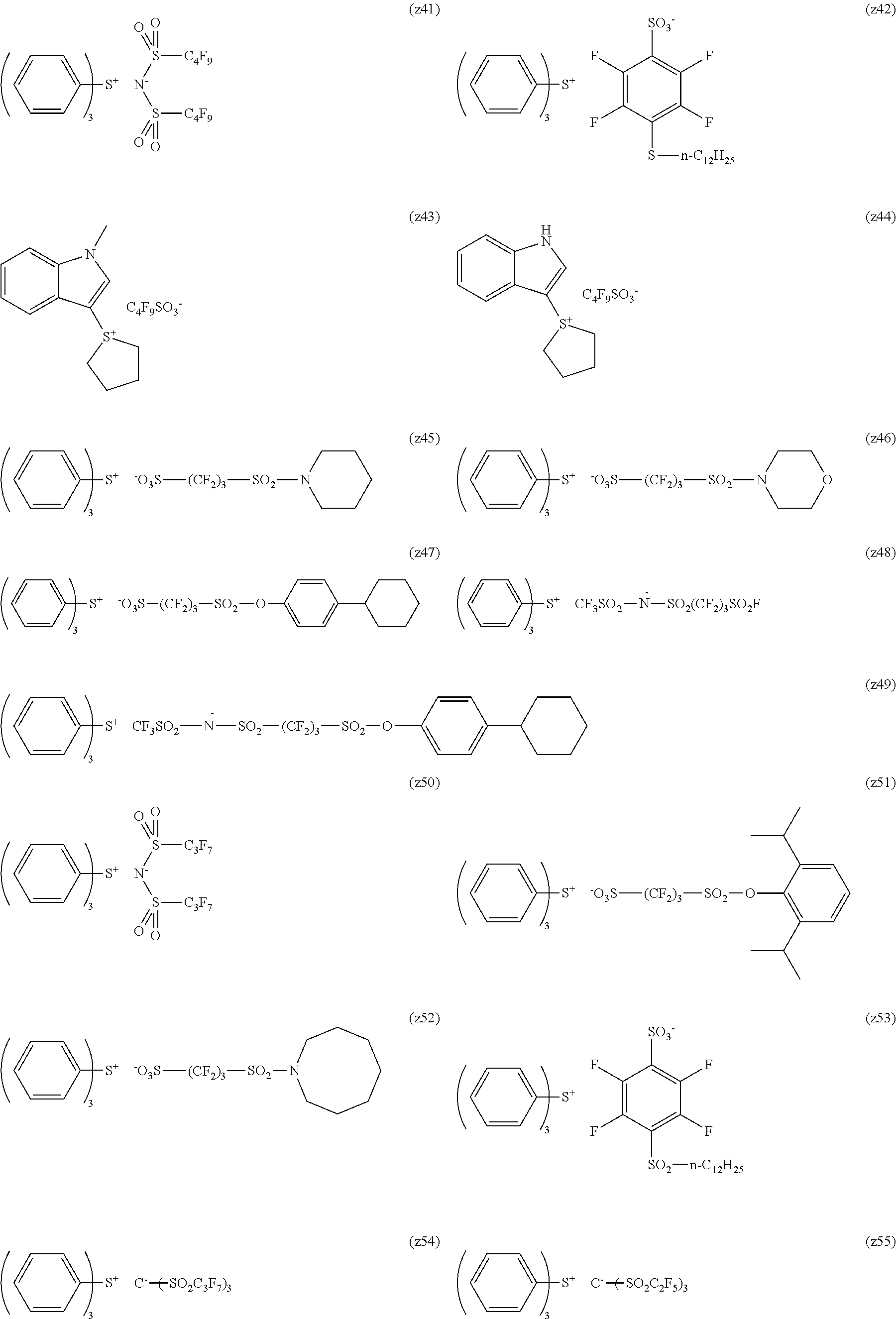

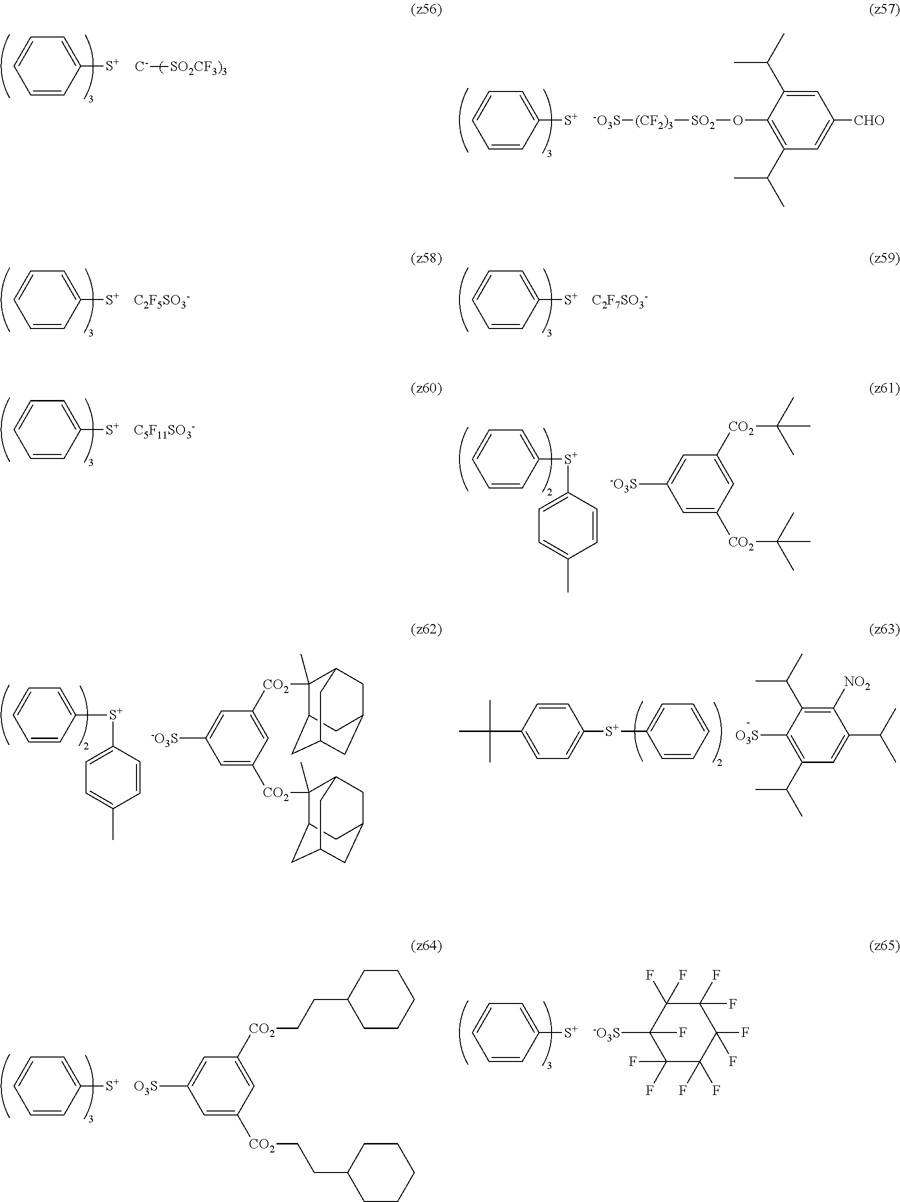

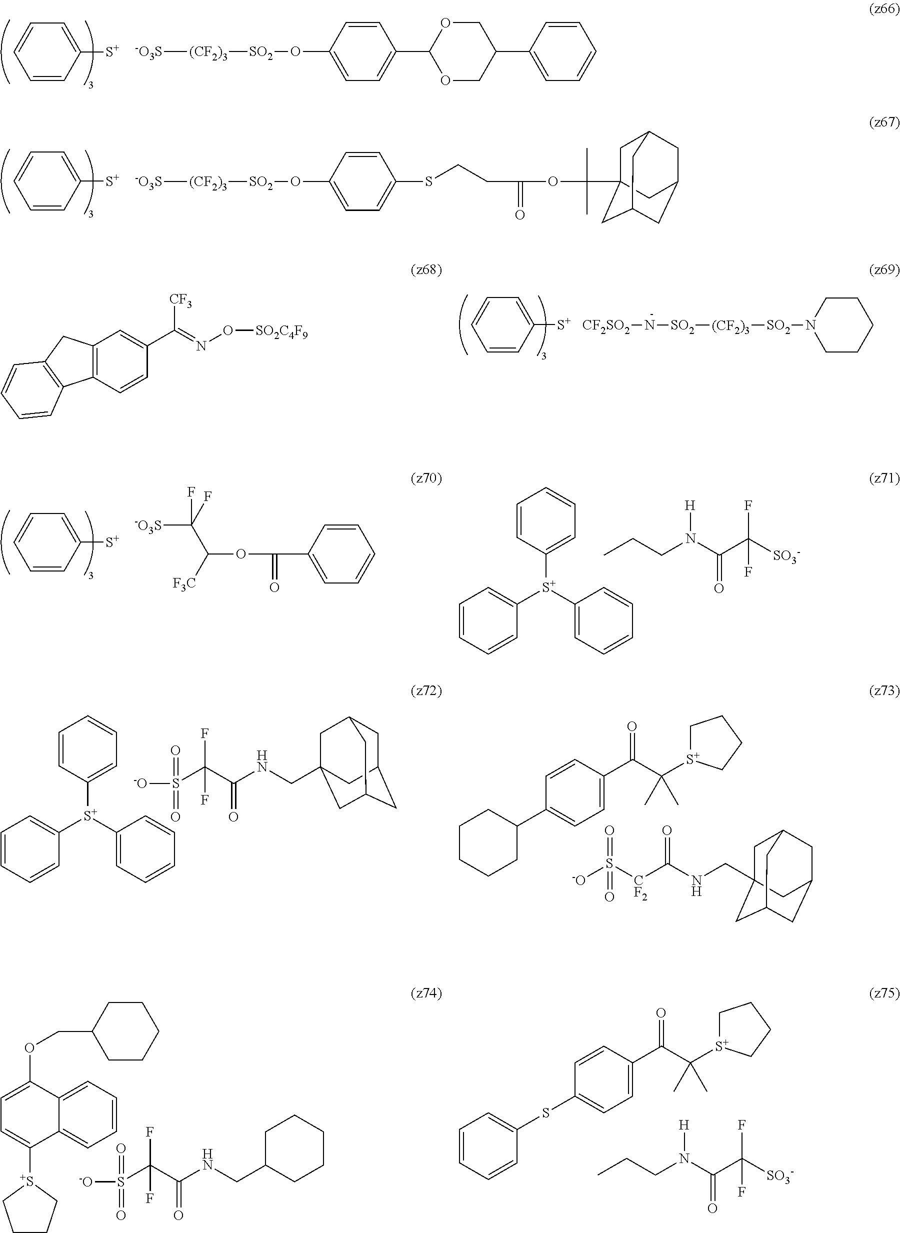

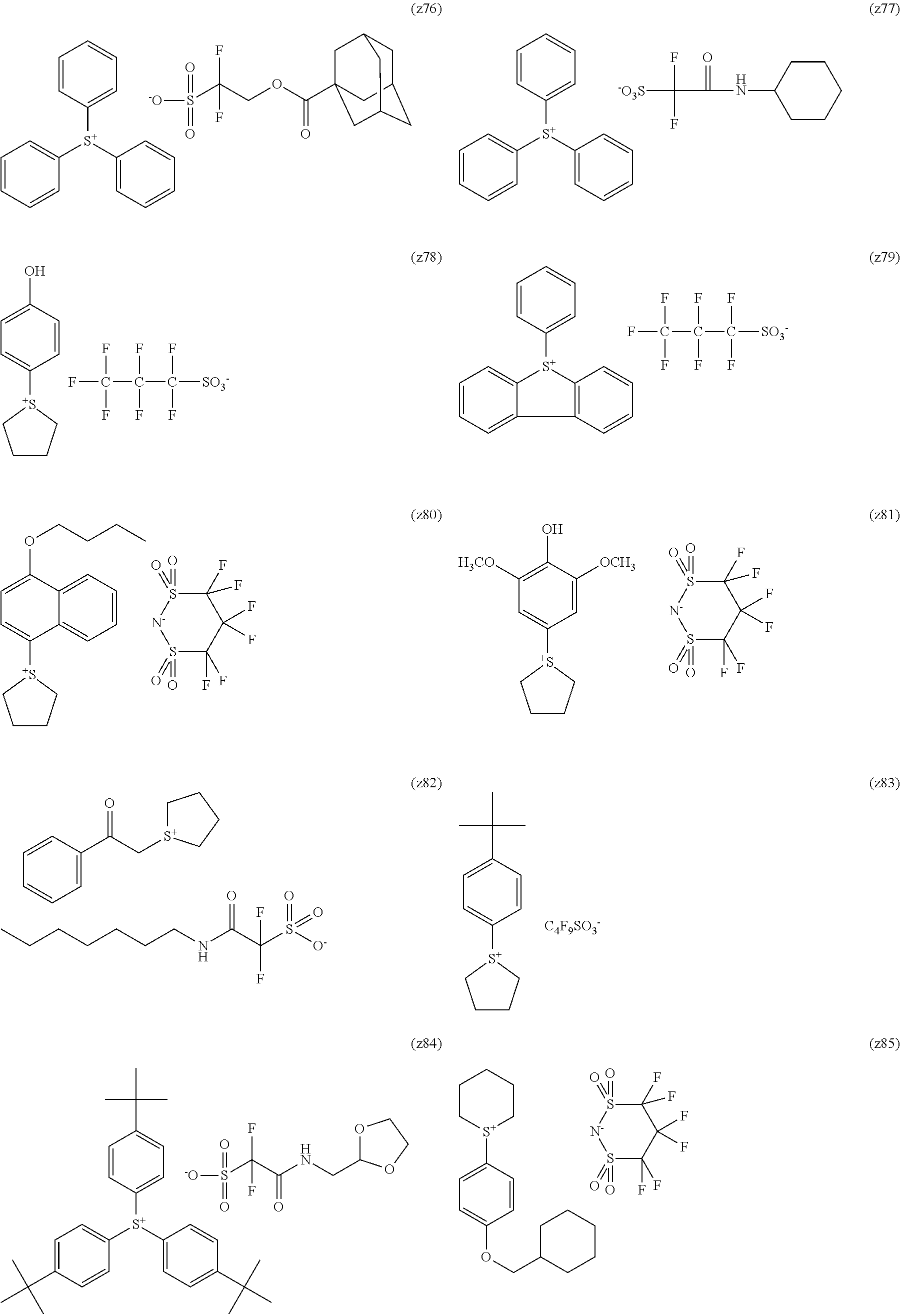

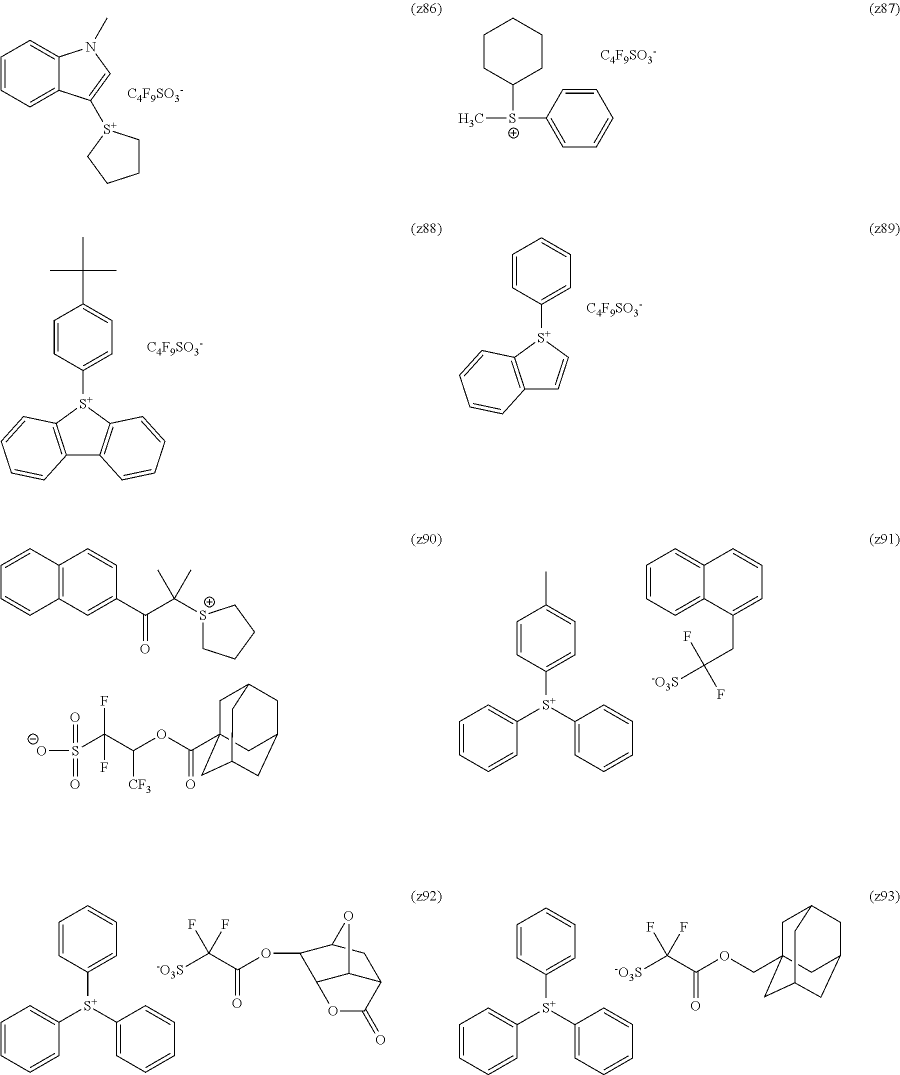

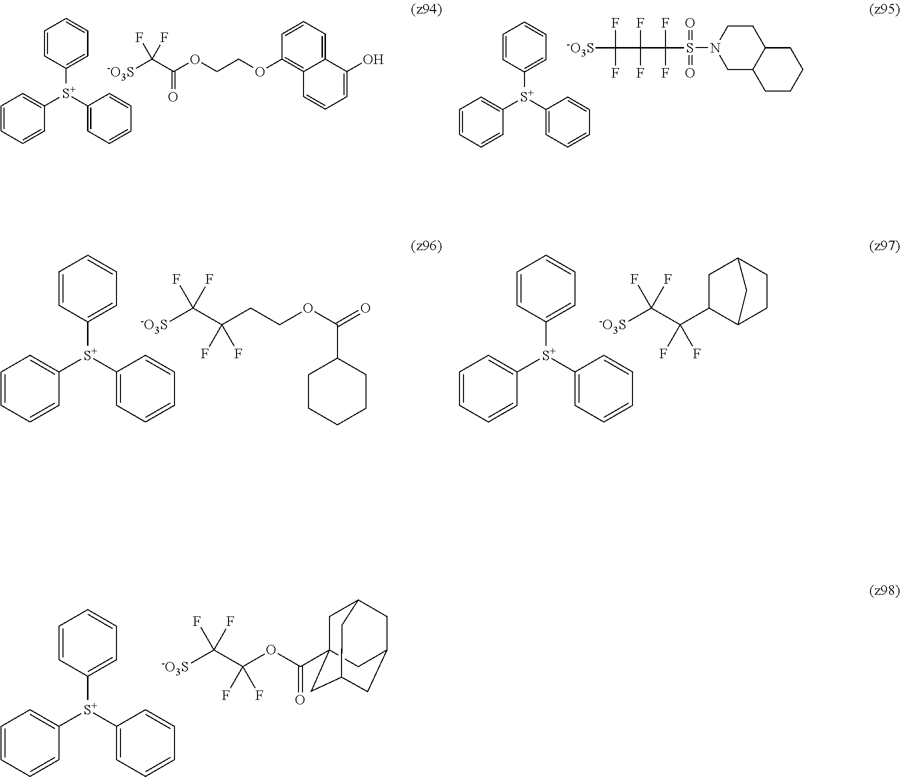

In a case where the total solid content (all components except for a solvent) of the composition for forming a hardcoat layer in the present invention is regarded as being 100% by mass, the content of (b) acid generator is preferably 0% to 5% by mass, more preferably 0.2% to 4% by mass, and even more preferably 0.4% to 3% by mass. In a case where the content is equal to or less than 5% by mass, the weather fastness of the film becomes excellent. In a case where the content is equal to or more than 0.2% by mass, it is possible to obtain excellent recoating properties even though an acid treatment is not performed.

The composition for forming a hardcoat layer of the present invention preferably further contains at least one kind of component among (c) compound having three or more ethylenically unsaturated double bond groups in a molecule, (d) compound having one or more epoxy groups in a molecule, (e) inorganic fine particles reactive with an epoxy group or an ethylenically unsaturated double bond group, and (f) ultraviolet absorber, (d) is more preferably a compound which has one alicyclic epoxy group and one ethylenically unsaturated double bond group in a molecule and has a molecular weight of equal to or less than 300.

<<(c) Compound Having Three or More Ethylenically Unsaturated Double Bond Groups in Molecule>>

It is preferable that the composition for forming a hardcoat layer of the present invention contains a compound (referred to as “compound (c)” or “(c) component” as well) having three or more ethylenically unsaturated double bond groups in a molecule.

Examples of the ethylenically unsaturated double bond group include a polymerizable functional group such as a (meth)acryloyl group, a vinyl group, a styryl group, and an allyl group. Among these, a (meth)acryloyl group and —C(O)OCH═CH₂ are preferable, and a (meth)acryloyl group is particularly preferable. By having the ethylenically unsaturated double bond groups, the compound can maintain high hardness, and moisture-heat resistance can be conferred. Furthermore, by having three or more ethylenically unsaturated double bond groups in a molecule, the compound can exhibit higher hardness.

Examples of the compound (c) include an ester of a polyhydric alcohol and a (meth)acrylic acid, vinyl benzene and a derivative thereof, vinyl sulfone, (meth)acrylamide, and the like. Among these, from the viewpoint of hardness, a compound having three or more (meth)acryloyl groups is preferable, and examples thereof include an acrylate-based compound that is widely used in the field of the related art and forms a cured substance having high hardness. Examples of such a compound include an ester of a polyhydric alcohol and (meth)acrylic acid {for example, pentaerythritol tetra(meth)acrylate, pentaerythritol tri(meth)acrylate, trimethylolpropane tri(meth)acrylate, EO-modified trimethylolpropane tri(meth)acrylate. PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate, caprolactone-modified tris(acryloxyethyl)isocyanurate, and the like}.

Specific examples of polyfunctional acrylate-based compounds having three or more (meth)acryloyl groups include KAYARAD DPHA, KAYARAD DPHA-2C, KAYARAD PET-30, KAYARAD TMPTA, KAYARAD TPA-320, KAYARAD TPA-330, KAYARAD RP-1040, KAYARAD T-1420, KAYARAD D-310, KAYARAD DPCA-20, KAYARAD DPCA-30, KAYARAD DPCA-60, and KAYARAD GPO-303 manufactured by Nippon Kayaku Co., Ltd., and a compound obtained by esterifying a polyol and (meth)acrylic acid, such as V#400 and V#36095D manufactured by OSAKA ORGANIC CHEMICAL INDUSTRY LTD. Furthermore, it is possible to suitably use urethane acrylate compounds having three or more functional groups, such as SHIKOH UV-1400B, SHIKOH UV-1700B, SHIKOH UV-6300B, SHIKOH UV-7550B, SHIKOH UV-7600B, SHIKOH UV-7605B, SHIKOH UV-7610B. SHIKOH UV-7620EA, SHIKOH UV-7630B, SHIKOH UV-7640B, SHIKOH UV-6630B, SHIKOH UV-7000B, SHIKOH UV-7510B, SHIKOH UV-7461TE, SHIKOH UV-3000B, SHIKOH UV-3200B, SHIKOH UV-3210EA, SHIKOH UV-3310EA, SHIKOH UV-3310B, SHIKOH UV-3500BA, SHIKOH UV-3520TL, SHIKOH UV-3700B, SHIKOH UV-6100B, SHIKOH UV-6640B, SHIKOH UV-2000B, SHIKOH UV-2010B, SHIKOH UV-2250EA, and SHIKOH UV-2750B (manufactured by NIPPON GOHSEI). UL-503LN (manufactured by KYOEISHA CHEMICAL Co., LTD), UNIDIC 17-806. UNIDIC 17-813, UNIDIC V-4030, and UNIDIC V-4000BA (manufactured by DIC Corporation), EB-1290K, EB-220, EB-5129, EB-1830, and B-4358 (manufactured by Daicel-UCB Company, Ltd.), HI-COAP AU-2010 and HI-COAP AU-2020 (manufactured by TOKUSHIKI Co., Ltd.). ARONIX M-1960 (manufactured by TOAGOSEI CO., LTD.), ART RESIN UN-3320HA, UN-3320HC, UN-3320HS, UN-904, and HDP-4T, polyester compounds having 3 or more functional groups such as ARONIX M-8100, M-8030, and M-9050 (manufactured by TOAGOSEI CO., LTD.) and KBM-8307 (manufactured by Daicel SciTech), and the like.

The compound (c) may be constituted with a single compound, or a plurality of compounds may be used in combination as the compound (c).

In a case where the total solid content (all components except for a solvent) of the composition for forming a hardcoat layer in the present invention is regarded as being 100% by mass, the content of the compound (c) is preferably 40% to 90% by mass, more preferably 45% to 85% by mass, and even more preferably 50% to 80% by mass. In a case where the content of the compound (c) is equal to or more than 40% by mass, sufficient hardness can be obtained. In a case where the content of the compound (c) is equal to or less than 90% by mass, the amount of the resin (a) does not become insufficient, the contact angle on the surface of the hardcoat layer can be reduced, and the smoothness is not impaired.

The equivalent of the ethylenically unsaturated bond groups in the compound (c) is preferably 80 to 130. The equivalent of ethylenically unsaturated bond groups refers to a numerical value obtained by dividing the molecular weight of the compound (c) by the number of ethylenically unsaturated bond groups.

The equivalent of the ethylenically unsaturated bond groups in the compound (c) is preferably 80 to 130, more preferably 80 to 110, and even more preferably 80 to 100.

<<(d) Compound Having One or More Epoxy Groups in Molecule>>

It is preferable that the composition for forming a hardcoat layer of the present invention contains a compound (referred to as “compound (d)” or “(d) component” as well) having one or more epoxy groups in a molecule.

The epoxy group contained in the compound (d) is not particularly limited, as long as the compound (d) contains one or more epoxy groups.

The molecular weight of the compound (d) is preferably equal to or less than 300, more preferably equal to or less than 250, and even more preferably equal to or less than 200. From the viewpoint of inhibiting the volatilization at the time of forming the hardcoat layer, the molecular weight of the compound (d) is preferably equal to or more than 100 and more preferably equal to or more than 150.

In a case where the aforementioned epoxy group is alicyclic, and the molecular weight is equal to or less than 300, hardness can be improved.

In a case where the total solid content of the composition for forming a hardcoat layer in the present invention is regarded as being 100% by mass, the content of the compound (d) is preferably 5% to 40% by mass, more preferably 7% to 35% by mass, and even more preferably 10% to 25% by mass. In a case where the content of the compound (d) is equal to or more than 5% by mass, smoothness is more effectively improved, and the surface condition of the hardcoat layer becomes excellent. In a case where the content of the compound (d) is equal to or less than 40% by mass, hardness is improved.

It is preferable that the compound (d) further contains an ethylenically unsaturated double bond group. The ethylenically unsaturated double bond group is not particularly limited, and examples thereof include a (meth)acryloyl group, a vinyl group, a styryl group, an allyl group, and the like. Among these, a (meth)acryloyl group and —C(O)OCH═CH₂ are preferable, and a (meth)acryloyl group is particularly preferable.

By having an ethylenically unsaturated double bond group, the compound (d) obtains an ability to be bonded to the compound (c). Accordingly, hardness can be further improved, and bleed-out at the time of exposure to moisture and heat can be inhibited.

The compound (d) is not particularly limited as long as it has one or more alicyclic epoxy groups in a molecule, and specifically, it is possible to use bicyclohexyl diepoxide; 3,4,3′,4′-diepoxybicyclohexyl, butanetetracarboxylic acid tetra(3,4-epoxycyclohexylmethyl) modified 8-caprolactone, a compound described in paragraph “0015” in JP 1998-17614A (JP-H10-17614A) or represented by General Formula (1A) or (1B), 1,2-epoxy-4-vinylcyclohexane, and the like. Among these, a compound represented by General Formula (1A) or (1B) is more preferable, and a compound represented by General Formula (1A) having a low molecular weight is even more preferable. As the compound represented by General Formula (1A), an isomer thereof is also preferable.

By using these compounds, it is possible to improve the smoothness of the hardcoat layer and to maintain high hardness.

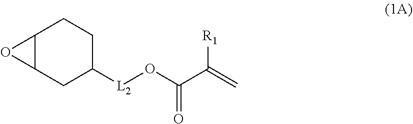

In General Formula (1A), R₁ represents a hydrogen atom or a methyl group, and L₂ represents a divalent aliphatic hydrocarbon group having 1 to 6 carbon atoms.

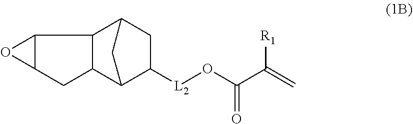

In General Formula (1B). R₁ represents a hydrogen atom or a methyl group, and L₂ represents a divalent aliphatic hydrocarbon group having 1 to 6 carbon atoms.

The number of carbon atoms in the divalent aliphatic hydrocarbon group represented by L₂ in General Formulae (1A) and (1B) is preferably 1 to 6, more preferably 1 to 3, and even more preferably 1. The divalent aliphatic hydrocarbon group is preferably a linear, branched, or cyclic alkylene group, more preferably a linear or branched alkylene group, and even more preferably a linear alkylene group.

<<(e) Inorganic Fine Particles>>

It is preferable that the composition for forming a hardcoat layer of the present invention contains inorganic fine particles (referred to as “inorganic fine particles (e)” or “(e) component” as well) reactive with an epoxy group or an ethylenically unsaturated double bond group.

By the addition of the inorganic fine particles (e), the hydrophilicity of the cured layer can be increased, and hence the contact angle can be reduced. Furthermore, a cure shrinkage amount of the cured layer can be reduced, and accordingly, film curling can be reduced. In addition, the use of the inorganic fine particles reactive with an epoxy group or an ethylenically unsaturated double bond group makes it possible to improve pencil hardness. Examples of the inorganic fine particles include silica particles, titanium dioxide particles, zirconium oxide particles, aluminum oxide particles, and the like. Among these, silica particles are preferable.

Generally, the affinity of the inorganic fine particles with an organic component such as a polyfunctional vinyl monomer is low. Therefore, in a case where the inorganic fine particles are simply mixed with the organic component, sometimes an aggregate is formed or the cured layer obtained after curing easily cracks. In order to improve the affinity of the inorganic fine particles with an organic component, the surface of the inorganic fine particles is treated with a surface modifier containing an organic segment.

It is preferable that the surface modifier has a functional group, which can form a bond with the inorganic fine particles or can be adsorbed onto the inorganic fine particles, and a functional group, which has high affinity with an organic component, in the same molecule. As the surface modifier having a functional group which can form a bond with the inorganic fine particles or can be adsorbed onto the inorganic fine particles, a metal alkoxide surface modifier such as silane, aluminum, titanium, and zirconium or a surface modifier having an anionic group such as a phosphoric acid group, a sulfuric acid group, a sulfonic acid group, or a carboxylic acid group is preferable. As the functional group having high affinity with an organic component, those obtained simply by combining an organic component with hydrophilicity and hydrophobicity may be used. However, as the functional group, a functional group that can be chemically bonded to an organic component is preferable, and an ethylenically unsaturated double bond group or a ring-opening polymerizable group is particularly preferable.

In the present invention, the surface modifier for the inorganic fine particles is preferably a curable resin having metal alkoxide or an anionic group and an ethylenically unsaturated double bond group or a ring-opening polymerizable group in the same molecule. By making the functional group chemically bonded to an organic component, crosslinking density of the hardcoat layer is increased, and pencil hardness can be improved.

Typical examples of the aforementioned surface modifiers include a silane coupling agent containing an unsaturated double bond, an organic curable resin containing a phosphoric acid group, an organic curable resin containing a sulfuric acid group, and an organic curable resin containing a carboxylic acid group shown below, and the like.

S-1 H₂C═C(X)COOC₃H₆Si(OCH₃)₃

S-2 H₂C═C(X)COOC₂H₄OTi(OC₂H₅)₃

S-3 H2C═C(X)COOC₂H₄OCOC₆H₁₀OPO(OH)₂

S-4 (H₂C—C(X)COOC₂H₄OCOC₅H₁₀O)₂POOH

S-5 H₂C═C(X)COOC₂H₄OSO₃H

S-6 H₂C═C(X)COO(C₅H₁₀COO)₂H

S-7 H₂C═C(X)COOC₅H₁₀COOH

S-8 CH₂CH(O)CH₂OC₃H₆Si(OCH₃)₃

(X represents a hydrogen atom or CH₃)

These surface modifiers for the inorganic fine particles are preferably in the form of a solution. The inorganic fine particles may be mechanically finely dispersed together with the surface modifier, or after the inorganic fine particles are finely dispersed, the surface modifier may be added thereto and stirred. Alternatively, a method may be used in which the surface of the inorganic fine particles are modified before the particles are finely dispersed (if necessary, heating or pH modification may be performed after the particles are warmed and dried) and then the particles are finely dispersed. As the solution in which the surface modifier is dissolved, an organic solvent having high polarity is preferable, and specific examples thereof include a known solvent such as an alcohol, a ketone, and an ester.

The average primary particle size of the inorganic fine particles (e) is preferably 10 nm to 100 nm, and more preferably 10 to 60 nm. The average particle size of fine particles can be determined from an electron micrograph. In a case where the particle size of the inorganic fine particles (e) is too small, a hardness improving effect is not obtained. In a case where the particle size of the inorganic fine particles (e) is too large, haze increases.

Specific examples of the inorganic fine particles (e) include ELECOM V-8802 (spherical silica particles having an average particle size of 12 nm manufactured by JGC CORPORATION), ELECOM V-8803 (silica particles of irregular shapes manufactured by JGC CORPORATION), MiBK-ST (spherical silica particles having an average particle size of 10 to 20 nm manufactured by NISSAN CHEMICAL INDUSTRIES, LTD.), MEK-AC-2140Z (spherical silica particles having an average particle size of 10 to 20 nm manufactured by NISSAN CHEMICAL INDUSTRIES, LTD.), MEK-AC-4130 (spherical silica particles having an average particle size of 40 to 50 nm manufactured by NISSAN CHEMICAL INDUSTRIES, LTD.), MiBK-SD-L (spherical silica particles having an average particle size of 40 to 50 nm manufactured by NISSAN CHEMICAL INDUSTRIES, LTD.), MEK-AC-5140Z (spherical silica particles having an average particle size of 70 to 100 nm manufactured by NISSAN CHEMICAL INDUSTRIES, LTD.), and the like.

In a case where the total solid content of the composition for forming a hardcoat layer is regarded as being 100% by mass, the content of the inorganic fine particles (e) is preferably 10% to 40% by mass, more preferably 10% to 30% by mass, and even more preferably 10% to 25% by mass.

<<(f) Ultraviolet Absorber>>

It is preferable that the composition for forming a hardcoat layer of the present invention contains an ultraviolet absorber (referred to as “ultraviolet absorber (f)” or “(f) component” as well).

The hardcoat film of the present invention is suitably used in a polarizing plate, a liquid crystal display member, and the like. From the viewpoint of preventing the deterioration of a polarizing plate, a liquid crystal, and the like, an ultraviolet absorber is preferably used. As the ultraviolet absorber, a substance is preferably used which can excellently absorb ultraviolet rays having a wavelength of equal to or shorter than 370 nm but hardly absorbs visible light having a wavelength of equal to or longer than 400 nm from the viewpoint of excellent liquid crystal display properties. One kind of ultraviolet absorber may be used singly, or two or more kinds thereof may be used in combination. Examples thereof include ultraviolet absorbers described in JP2001-72782A or JP2002-543265A. Specific examples of the ultraviolet absorber include an oxybenzophenone-based compound, a benzotriazole-based compound, a salicylic acid ester-based compound, a benzophenone-based compound, a cyanoacrylate-based compound, a nickel complex salt-based compound, and the like.

In a case where the total solid content of the composition for forming a hardcoat layer is regarded as being 100% by mass, the content of the ultraviolet absorber (f) is 0.1% to 3% by mass. The content of the ultraviolet absorber (f) is preferably 0.2% to 2.5% by mass, and more preferably 0.3% to 2% by mass.

<<Solvent>>

In the present invention, the composition for forming a hardcoat layer can contain a solvent. As the solvent, various solvents can be used in consideration of the solubility of each component, the dispersibility of the particles, the drying properties at the time of coating, and the like. Examples of the organic solvent include dibutylether, dimethoxyethane, diethoxyethane, propylene oxide, 1,4-dioxane, 1,3-dioxolane, 1,3,5-trioxane, tetrahydrofuran, anisole, phenetole, dimethyl carbonate, methyl ethyl carbonate, diethyl carbonate, acetone, methyl ethyl ketone (MEK), diethyl ketone, dipropyl ketone, diisobutyl ketone, cyclopentanone, cyclohexanone, methyl cyclohexanone, ethyl formate, propyl formate, pentyl formate, methyl acetate, ethyl acetate, propyl acetate, methyl propionate, ethyl propionate, γ-butyrolactone, methyl 2-methoxyacetate, methyl 2-ethoxyacetate, ethyl 2-ethoxyacetate, ethyl 2-ethoxypropionate, 2-methoxyethanol, 2-propoxyethanol, 2-butoxyethanol, 1,2-diacetoxyacetone, acetyl acetone, diacetone alcohol, methyl acetoacetate, ethyl acetoacetate, methyl alcohol, ethyl alcohol, isopropyl alcohol, n-butyl alcohol, cyclohexyl alcohol, isobutyl acetate, methyl isobutyl ketone (MIBK), 2-octanone, 2-pentanone, 2-hexanone, ethylene glycol ethyl ether, ethylene glycol isopropyl ether, ethylene glycol butyl ether, propylene glycol methyl ether, ethyl carbitol, butyl carbitol, hexane, heptane, octane, cyclohexane, methyl cyclohexane, ethyl cyclohexane, benzene, toluene, xylene, methanol, ethanol, tert-butyl alcohol, and the like. One kind of the organic solvent can be used singly, or two or more kinds thereof can be used in combination.

In the present invention, the solvent is used such that the concentration of the solid content of the composition for forming a hardcoat layer is preferably within a range of 20% to 80% by mass, more preferably within a range of 30% to 75% by mass, and even more preferably within a range of 40% to 70% by mass.

The inventors of the present invention found that even in a case where the hardcoat layer formed using the aforementioned composition for forming a hardcoat layer is used as an underlayer, and an overlayer is formed on the surface of the underlayer by means of coating, cissing does not easily occur at the time of coating, and an overlayer without unevenness that has a uniform surface can be prepared. Although the present invention does not adhere to any theory, it is considered that, as described above, at the time of coating, in the hardcoat layer formed of the composition for forming a hardcoat layer containing the resin (a) having a surface smoothing (leveling) function, due to an acid generated from the acid generator by irradiating the hardcoat layer with ionizing radiation such as ultraviolet rays at the time of hardening the hardcoat layer or by the acid treatment performed for neutralization at the time of performing a saponification treatment on the film after the hardcoat layer is hardened, the acid decomposable group of the resin (a) is decomposed, and hence the polarity changes. As a result, the surface of the hardcoat layer is hydrophilized, and it is possible to prevent the occurrence of cissing at the time of forming the overlayer. Due to the aforementioned properties, in a case where a layer formed of the composition for forming a hardcoat layer of the present invention is used as an underlayer, and an overlayer is formed on the surface of the underlayer by means of coating, a wide variety of solvents can be used as the solvent of the coating solution for forming the overlayer.

<<Other Additives>>

The composition for forming a hardcoat layer may contain additives such as a polymerization initiator in addition to (a) to (f) described above.

(Radical Polymerization Initiator)

The composition for forming a hardcoat layer in the present invention may contain a radical polymerization initiator.

The polymerization of a compound having an ethylenically unsaturated double bond group can be performed by the irradiation of ionizing radiation or heating in the presence of a photoradical polymerization initiator or a thermal radical polymerization initiator. As the photo and thermal polymerization initiators, commercially available compounds can be used. The compounds are described in “The Latest UV Curing Technology” (p. 159, publisher; Kazuhiro Takausu, publishing company. TECHNICAL INFORMATION INSTITUTE CO., LTD., 1991) or a catalog from BASF SE.

Specifically, as the radical polymerization initiator, it is possible to use alkylphenone-based photopolymerization initiators (Irgacure 651, Irgacure 184, DAROCURE 1173, Irgacure 2959, Irgacure 127, DAROCURE MBF, Irgacure 907, Irgacure 369, and Irgacure 379EG), acylphosphine oxide-based photopolymerization initiators (Irgacure 819 and LUCIRIN TPO), others (Irgacure 784, Irgacure OXE01, Irgacure OXE02, and Irgacure 754), and the like.

In a case where the total solid content of the composition for forming a hardcoat layer in the present invention is regarded as being 100% by mass, the amount of the radical polymerization initiator added is preferably within a range of 0.1% to 10% by mass, more preferably 1% to 5% by mass, and more preferably 2% to 4% by mass. Among the above, one kind of radical polymerization initiator may be used singly, or plural kinds of radical polymerization initiators can be used in combination.

(Air Blow Unevenness Inhibitor)

The composition for forming a hardcoat layer in the present invention may contain an air blow unevenness inhibitor.

(Fluorine-Based Surfactant and Silicone-Based Surfactant)

The composition for forming a hardcoat layer may contain a fluorine-based surfactant and a silicone-based surfactant. However, in this case, hydrophobicity is enhanced, and the contact angle increases. Therefore, it is preferable that the composition practically does not contain such surfactants. In a case where the composition does not contain such surfactants, the surface of the formed hardcoat layer is not easily hydrophobized, and cissing does not easily occur at the time of forming an overlayer.

Specifically, the content of the fluorine-based surfactant and the silicone-based surfactant in the composition for forming a hardcoat layer is, with respect to the total mass of the composition for forming a hardcoat layer, equal to or less than 0.05% by mass, preferably equal to or less than 0.01% by mass, and more preferably 0% by mass.

The fluorine-based surfactant is a compound which contains fluorine and is localized on the surface of a solvent used in the composition for forming a hardcoat layer. Examples of the fluorine-based surfactant having a hydrophobic portion include fluorine-containing compounds among the compounds described as alignment control agents in paragraphs “0028” to “0034” in JP2011-191582A, the fluorine-based surfactants described in JP2841611B, the fluorine-based surfactants described in paragraphs “0017” to “0019” in JP2005-272560A, and the like.

Examples of commercially available fluorine-based surfactants include SURFLON manufactured by AGC SEIMI CHEMICAL CO., LTD., MEGAFACE manufactured by DIC Corporation, and FTERGENT manufactured by NEOS COMPANY LIMITED.

The silicone-based surfactant is a compound which contains silicone and is localized on the surface of a solvent used in a composition for preparing an optical functional layer.

Examples of the silicone-based surfactant include silicon atom-containing low-molecular weight compounds such as polymethyl phenyl siloxane, polyether-modified silicone oil, polyether-modified dimethyl polysiloxane, dimethyl silicone, diphenyl silicone, hydrogen-modified polysiloxane, vinyl-modified polysiloxane, hydroxy-modified polysiloxane, amino-modified polysiloxane, carboxyl-modified polysiloxane, chloro-modified polysiloxane, epoxy-modified polysiloxane, methacryloxy-modified polysiloxane, mercapto-modified polysiloxane, fluorine-modified polysiloxane, long-chain alkyl-modified polysiloxane, phenyl-modified polysiloxane, and a silicone-modified copolymer.

Examples of commercially available products of the silicone-based surfactant include KF-96 and X-22-945 manufactured by Shin-Etsu Chemical Co., Ltd., TORAY SILICONE DC3PA, TORAY SILICONE DC7PA, TORAY SILICONE SH11PA, TORAY SILICONE SH21PA, TORAY SILICONE SH28PA, TORAY SILICONE SH29PA, TORAY SILICONE SH30PA, and TORAY SILICONE FS-1265-300 (all manufactured by Dow Corning Torav Silicone Co., Ltd.), TSF-4300, TSF-4440, TSF-4445, TSF-4446, TSF-4452, and TSF-4460, (all manufactured by GE Toshiba Silicones, Co., Ltd.), a polysiloxane polymer KP341 (manufactured by Shin-Etsu Chemical Co., Ltd.), BYK-301, BYK-302, BYK-307, BYK-325, BYK-331, BYK-333, BYK-341, BYK-345, BYK-346, BYK-348, and BYK-375 (manufactured by BYK-Chemie Japan K.K.), ARON GS-30 (manufactured by TOAGOSEI CO., LTD.), SILICONE L-75, SILICONE L-76, SILICONE L-77, SILICONE L-78, SILICONE L-79, SILICONE L-520, and SILICONE L-530 (manufactured by NIPPON UNICAR COMPANY LIMITED), and the like.

<Support>

As the support, a transparent support having a visible light (400 to 800 nm) transmittance of equal to or higher than 80% is preferable, and glass or a polymer film can be used. Examples of materials of the polymer film used as the support include a cellulose acylate film (for example, a cellulose triacetate film, a cellulose diacetate film, a cellulose acetate butyrate film, and a cellulose acetate propionate film), polyolefin such as polyethylene or polypropylene, a polyester-based resin film such as polyethylene terephthalate or polyethylene naphthalate, a polyethersulfone film, a polyacryl-based resin film such as polymethyl methacrylate, a polyurethane-based resin film, a polyester film a polycarbonate film, a polysulfone film, a polyether film, a polymethylpentene film, a polyether ketone film, a (meth)acrylnitrile film, a polyolefin, a polymer having an alicyclic structure (norbornene-based resin (ARTON: trade name, manufactured by JSR Corporation), amorphous polyolefin (ZEONEX: trade name, manufactured by ZEON CORPORATION)), and the like. Among these, a cellulose acylate film is preferable.

The support may be a temporary support that is peeled off after the hardcoat layer is formed.

The film thickness of the support may be about 1 μm to 1,000 μm. It is preferable that the support is made into a thin layer so as to be used in mobile devices. Therefore, the film thickness thereof is more preferably 1 μm to 100 μm, and even more preferably 1 μm to 25 μm.

[Method for Manufacturing Hardcoat Film]

The hardcoat film of the present invention can be manufactured by coating a support with the aforementioned composition for forming a hardcoat layer and drying and curing the composition to form a hardcoat layer.

In a case where the composition for forming a hardcoat layer containing the aforementioned resin (a) and (b) acid generator is used, by irradiating the composition with ionizing radiation in the drying and curing steps, (b) acid generator generates an acid. Due to the acid, the acid decomposable group in the resin (a) is decomposed, and hence the hydrophilicity increases.

In another aspect of the present invention, a support is coated with the composition for forming a hardcoat layer containing the resin (a), and the obtained hardcoat layer is subjected to the acid treatment. In this way, the acid decomposable group in the resin (a) is decomposed, and hence the hydrophilicity increases.

<Coating Method>

Each layer of the hardcoat film of the present invention can be formed by the following coating methods, but the present invention is not limited to the methods. Known methods such as a dip coating method, an air knife coating method, a curtain coating method, a roller coating method, a wire bar coating method, a gravure coating method, a slide coating method, an extrusion coating method (die coating method) (see JP2003-164788A), and a micro-gravure coating method are used. Among these, a micro-gravure coating method and a die coating method are preferable.

<Drying and Curing Condition>

Hereinbelow, preferred examples of the drying and curing methods used in a case where the hardcoat layer or the like in the present invention is formed by coating will be described.

In the present invention, it is effective to perform curing by combining the irradiation of ionizing radiation with a heat treatment which is performed before the irradiation, simultaneously with the irradiation, or after the irradiation.

Some patterns of the manufacturing process will be shown below, but the present invention is not limited thereto (“−” shown below means that the heat treatment is not performed).

| | Before | | After |
|---|---|---|---|
| | irradiation → | Simultaneously with irradiation → | irradiation |
| (1) | Heat | Curing by ionizing radiation → | — |
| | treatment → | | |
| (2) | Heat | Curing by ionizing radiation → | Heat |
| | treatment → | | treatment |
| (3) | — → | Curing by ionizing radiation → | Heat |
| | | | treatment |

In addition, a step of performing the heat treatment simultaneously with the curing by ionizing radiation is also preferable.

In the present invention, as described above, it is preferable to perform the irradiation of ionizing radiation and the heat treatment in combination. The heat treatment is not particularly limited as long as the layers constituting the hardcoat film including the support and the hardcoat layer are not damaged. The heat treatment is preferably performed at 30° C. to 150° C., and more preferably performed at 30° C. to 80° C.

Although the time required for the heat treatment varies with the molecular weight of the components used, the interaction with other components, the viscosity, and the like, it is 15 seconds to 1 hour, preferably 20 seconds to 30 minutes, and most preferably 30 seconds to 5 minutes.

The type of the ionizing radiation is not particularly limited, and examples thereof include X-rays, electron beams, ultraviolet rays, visible light, infrared rays, and the like, and among these, ultraviolet rays are widely used. For example, in a case where the coating film can be cured by ultraviolet rays, it is preferable to cure each layer by irradiating the layer with ultraviolet rays from an ultraviolet lamp in an irradiation amount of 10 mJ/cm² to 1,000 mJ/cm². At the time of irradiation, the aforementioned energy may be applied at once, or each layer can be irradiated with the energy in divided portions. Particularly, from the viewpoint of reducing the variation in performance within the surface of the coating film and ameliorating curling, it is preferable to dividedly perform the irradiation two or more times. Furthermore, it is preferable that ultraviolet rays are radiated at a low irradiance which is equal to or lower than 150 mJ/cm² at the early stage and then radiated at a high irradiance which is equal to or higher than 50 mJ/cm², and the irradiation amount is increased further in the late stage than in the early stage. In order to make the aforementioned (b) acid generator act, it is preferable to perform the irradiation in a high irradiation amount and to radiate ultraviolet rays in an irradiation amount of equal to or higher than 200 mJ/cm².

In a case where the acid treatment is performed on the hardcoat layer formed by means of coating by using the composition for forming a hardcoat layer containing the resin (a), examples of the acid treatment include an acid treatment for neutralization carried out at the time of performing a saponification treatment on the film. Although the acid treatment condition is not particularly limited, it is preferable to immerse the film in a 0.01 to 1 mol/L aqueous sulfuric acid solution for 5 seconds to 10 minutes and then rinse and dry the film.

It is preferable that the hardcoat film of the present invention is manufactured by the aforementioned method for manufacturing a hardcoat film of the present invention.

Generally, the simplest constitution of the hardcoat film of the present invention includes a support and a hardcoat layer formed on the support by coating.

Examples of preferred layer constitutions of the hardcoat film of the present invention will be shown below, but the present invention is not particularly limited to these layer constitutions.
Support/hardcoat layer
Support/hardcoat layer/layer of low refractive index
Support/hardcoat layer/antiglare layer (antistatic layer)/layer of low refractive index
Support/hardcoat layer/antiglare layer/antistatic layer/layer of low refractive index
Support/hardcoat layer/antistatic layer/antiglare layer/layer of low refractive index
Support/hardcoat layer (antistatic layer)/antiglare layer/layer of low refractive index
Support/hardcoat layer/layer of high refractive index/antistatic layer/layer of low refractive index
Support/hardcoat layer/layer of high refractive index (antistatic layer)/layer of low refractive index
Support/hardcoat layer/antistatic layer/layer of high refractive index/layer of low refractive index
Support/hardcoat layer/layer of medium refractive index/layer of high refractive index (antistatic layer)layer of low refractive index
Support/hardcoat layer/layer of medium refractive index (antistatic layer)/layer of high refractive index/layer of low refractive index
Support/hardcoat layer (antistatic layer)/layer of medium refractive index/layer of high refractive index/layer of low refractive index
Support/antistatic layer/hardcoat layer/layer of medium refractive index/layer of high refractive index/layer of low refractive index
Antistatic layer/support/hardcoat layer/layer of medium refractive index/layer of high refractive index/layer of low refractive index
Herein, the antistatic layer and the antiglare layer may have hard coat properties.

Although the film thickness of the hardcoat layer of the present invention can be selected according to the intended hardness, it is preferably 1 to 50 μm for the following reason. That is, because curling extremely hardly occurs in the hardcoat film of the present invention, even if the thickness of the hardcoat layer is increased, there is no problem with handleability. In a case where the hardcoat film is used as a polarizer protect film, the thickness of the hardcoat layer is preferably designed to be 3 to 10 μm.

<Polarizing Plate>

The polarizing plate of the present invention includes at least one sheet of the hardcoat film of the present invention and a polarizer. In the aspect in which the acid treatment is performed, it is preferable to perform the saponification treatment including the acid treatment on the film and then bond the film to a polarizer.

The hardcoat film of the present invention can be used as a protect film for a polarizing plate. In a case where the hardcoat film of the present invention is used as a protect film for a polarizing plate, the method for preparing the polarizing plate is not particularly limited, and the polarizing plate can be prepared by a general method such as a method of performing an alkali treatment on the obtained hardcoat film and bonding the hardcoat film onto both surfaces of a polarizer, which is prepared by immersing and elongating a polyvinyl alcohol film in an iodine solution, by using an aqueous polyvinyl alcohol solution. Instead of the alkali treatment, the easy adhesion processing described in JP 1994-94915A (JP-H06-94915A) or JP 1994-118232A (JP-H06-118232A) may be performed. Furthermore, the aforementioned surface treatment may be performed.

Examples of adhesives used for bonding the treated surface of the protect film to the polarizer include a polyvinyl alcohol-based adhesive such as polyvinyl alcohol or polyvinyl butyral, vinyl-based latex such as butyl acrylate, and the like.

The polarizing plate is constituted with a polarizer and a protect film protecting both surfaces of the polarizer, with a protect film bonded to one surface of the polarizing plate and a separating film bonded to the opposite surface. The protect film and the separating film are used for the purpose of protecting the polarizing plate at the time of shipping the polarizing plate, inspecting the product, and the like. In this case, the protect film is bonded for the purpose of protecting the surface of the polarizing plate, and used on a surface side opposite to a surface of the polarizing plate that will be bonded to a liquid crystal plate. The separating film is used on a surface side of the polarizing plate that will be bonded to the liquid crystal plate, for the purpose of covering the adhesive layer that will be bonded to the liquid crystal plate.

<Touch Panel Display>

The touch panel display of the present invention includes a liquid crystal cell and the polarizing plate of the present invention on a viewing side of the liquid crystal cell. It is preferable that the touch panel display includes an optically clear resign (OCR) or an optically clear adhesive (OCA) on a surface of the polarizing plate opposite to the liquid crystal cell.

### EXAMPLES

Hereinafter, the present invention will be more specifically described using examples. The materials, the reagents, the amount and proportion of substances, the operation, and the like shown in the following examples can be appropriately changed within a range that does not depart from the gist of the present invention. Accordingly, the scope of the present invention is not limited to the following examples.

<Preparation of Composition for Forming a Hardcoat Layer>

Based on the composition shown in Tables 1 to 4, compositions for forming a hardcoat layer (coating solutions for a hardcoat layer) A01 to A25 having a concentration of solid contents of 50% by mass were prepared. In Tables 1 to 4, “%” represents “% by mass”, the numerical value relating to a solvent represents a content rate of each solvent with respect to all solvents, and the numerical value relating to other components represents a content rate thereof in components in the coating solution for a hardcoat layer excluding a solvent.

<<(c) Component>>
DPHA: KAYARAD DPHA (manufactured by Nippon Kayaku Co., Ltd.) (Hexafunctional)
UV 1700B: urethane (meth)acrylate (manufactured by The Nippon Synthetic Chemical Industry Co., Ltd.) (decafunctional)
A-DCP: tricyclodecane dimethanol diacrylate (manufactured by SHIN-NAKAMURA CHEMICAL CO., LTD.)

<<(b) Component: Acid Generator>>
Compound B-1: the following compound, synthesized by the method described in Example 1 in JP4841935B

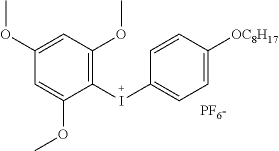

B2380: bis(4-tert-butylphenyl)iodonium hexafluorophosphate (manufactured by TOKYO CHEMICAL INDUSTRY CO., LTD.)

<<(a) Component>>
Compounds A-1 to A-4:
A-1 (a:b=80:50)(molar ratio), Mw=7000, Mw/Mn=1.4
A-1 (a:b=30:70)(molar ratio), Mw=9000, Mw/Mn=1.4
A-1 (s:b=10:9) (molar ratio), Mw=6000, Mw/Mn=1.3

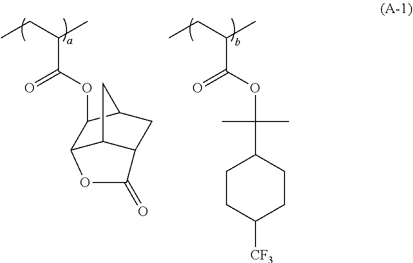

A-2: Mw=10000, Mw/Mn=1.5

The ratio of the following repeating unit is a molar ratio.

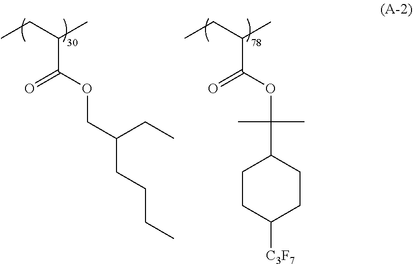

A-3:Mw=8000, Mw/Mn=1.4

The ratio of the following repeating unit is a molar ratio.

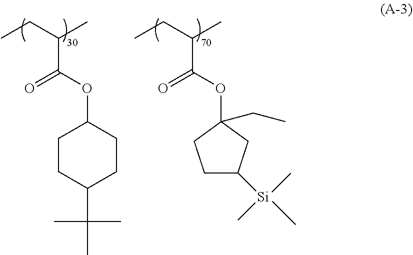

A-4: Mw=12000, Mw/Mn=1.5

The ratio of the following repeating unit is a molar ratio.

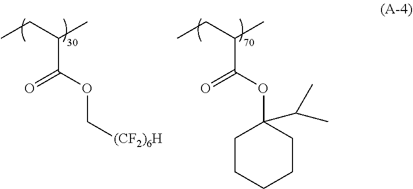

<<(g) Component: Leveling Agent not Containing Polarity Changing Group>>
FTERGENT 610FM: (manufactured by NEOS COMPANY LIMITED)
Compound G-1: the following fluorine-containing compound (Mw: 20.000)

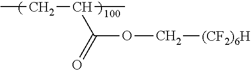

<<(d) Component>>
3,4-Epoxycyclohexylmethyl methacrylate: CYCLOMER M100 (manufactured by DAICEL CORPORATION, molecular weight: 196)
3′,4′-Epoxycyclohexylmethyl-3,4-epoxycyclohexane carboxylate: CELLOXIDE 2021P (manufactured by DAICEL CORPORATION, molecular weight: 252)
Glycidyl methacrylate:

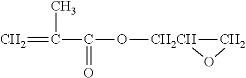

<<(h) Component: Polymerization Initiator>>
IRGACURE 184: alkylphenone-based polymerization initiator (manufactured by BASF SE)

<<(e) Inorganic Fine Particles>>
ELECOM V-8802: MiBK dispersion with solid content of spherical silica particles of 40% by mass having an average particle size of 12 nm and containing a polymerizable group (manufactured by JGC CORPORATION)
MiBK-ST: MiBK dispersion with solid content of silica particles of 30% by mass having an average particle size of 10 to 20 nm and free of polymerizable group (manufactured by NISSAN CHEMICAL INDUSTRIES, LTD.)

<<(f) Component: Ultraviolet Absorber>>
Tinuvin 928: benzotriazole-based ultraviolet absorber (manufactured by BASF SE)

<<Solvent>>
MEK: methyl ethyl ketone
MiBK: methyl isobutyl ketone
Methyl acetate

<Preparation of Cellulose Acylate Film>

(Preparation of Cellulose Acylate Dope for Core Layer)

The following composition was put into a mixing tank and stirred such that each component dissolved, thereby preparing a cellulose acetate solution.

| | | |
|---|---|---|
| Cellulose acetate with a degree of | 100 | parts by mass |
| acetyl substitution of 2.88 | | |
| Ester oligomer | 10 | parts by mass |
| Polarizer durability improver | 4 | parts by mass |
| Ultraviolet absorber (compound represented | 2 | parts by mass |
| by the following structural formula) | | |
| Methylene chloride (first solvent) | 430 | parts by mass |
| Methanol (second solvent) | 64 | parts by mass |

The ester oligomer is a condensate of dicarboxylic acid (adipic acid:phthalic acid=3:7 molar ratio) and ethylene glycol, has an acetyl group on the terminal thereof, and has a molecular weight of 1,000.

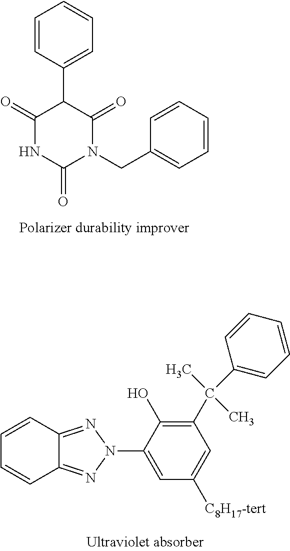

(Preparation of Cellulose Acylate Dope for Outer Layer)

10 parts by mass of the following matting agent solution was added to 90 parts by mass of the aforementioned cellulose acylate dope for a core layer, thereby preparing a cellulose acetate dope for an outer layer.

Matting Agent Solution

| | | |
|---|---|---|
| Silica particles having an average | 2 | parts by mass |
| particle size of 20 nm (AEROSIL R972, | | |
| manufactured by NIPPON AEROSIL CO., LTD) | | |
| Methylene chloride (first solvent) | 76 | parts by mass |
| Methanol (second solvent) | 11 | parts by mass |
| Cellulose acylate dope for core layer | 1 | part by mass |

(Preparation of Cellulose Acylate Film)

The cellulose acylate dope for a core layer and the cellulose acylate dope for an outer layer, which was positioned on both sides of cellulose acylate dope for a core layer, were simultaneously cast as 3 layers from a casting outlet onto a drum with a temperature of 20° C. In a state where the content rate of the solvent was about 20% by mass, the film was peeled off, and both ends of the film in the width direction were fixed to tenter clips. In a state where the content rate of the residual solvent was 3% to 15% by mass, the film was dried while being stretched by a factor of 1.1 in the transverse direction. Then, the film was further dried by being transported between rolls of a heat treatment device, thereby preparing a cellulose acylate film (25 μm TAC) having a thickness of 25 μm. The film thickness ratio between the respective layers at this time was outer layer on support side:inner layer:outer layer on air interface side=3:94:3. Furthermore, by changing the flow rate of the dope, a cellulose acylate film (40 μm TAC) having a film thickness of 40 μm was prepared.

(Preparation of Acryl Substrate Film)

A reaction tank having an internal volume of 30 L equipped with a stirring device, a thermometer sensor, a cooling pipe, and a nitrogen introduction pipe was filled with 8,000 g of methyl methacrylate (MMA), 2,000 g of methyl 2-(hydroxymethyl)acrylate, and 10,000 g of toluene as a polymerization solvent, and the solution was heated to 105° C. under a nitrogen gas stream. At a point in time when reflux started as a result of heating, 10.0 g of t-amylperoxyisononanoate as a polymerization initiator was added thereto, and in a state where a solution composed of 20.0 g of t-amylperoxyisononanoate and 100 g of toluene was being added dropwise thereto for 2 hours, solution polymerization was carried out under reflux at a temperature of about 105° C. to 110° C. Then, the solution was matured for 4 hours. The polymerization reaction rate was 96.6% and the content rate (weight ratio) of MHMA in the obtained polymer was 20.0%.

Thereafter, as a cyclization catalyst, 10 g of a mixture of stearyl phosphate/distearyl phosphate (SAKAI CHEMICAL INDUSTRY CO., LTD., Phoslex A-18) was added to the obtained polymerized solution, and a cyclization condensation reaction was carried out for 5 hours under reflux at a temperature of about 80° C. to 100° C.

Then, the obtained polymerized solution was introduced into a vent type double-screw extruder (φ=29.75 mm. L/D=30), which had a barrel temperature of 260° C., a rotation speed of 100 rpm, a degree of pressure reduction of 13.3 to 400 hPa (10 to 300 mmHg), one rear vent, and four fore vents, at a processing speed of 2.0 kg/hr in terms of the amount of resin, and a cyclization condensation reaction and devolatilization were performed in the extruder. Then, after the devolatilization was finished, the thermally melted resin remaining in the extruder was discharged from the distal end of the extruder and made into pellets by using a pelletizer, thereby obtaining transparent pellets formed of an acryl resin having a lactone ring structure on a main chain. The resin had a weight-average molecular weight of 148,000, a melt flow rate of 11.0 g/10 min (determined based on JIS K7120 at a test temperature of 240° C. under a load of 10 kg, the same shall be applied to the following manufacturing examples), and a glass transition temperature of 130° C.

Subsequently, the obtained pellets and an AS resin (manufactured by TOYO-STYRENE CO., LTD., trade name: TOYO AS AS-20) were kneaded at a weight ratio of pellets/AS resin=90/10 by using a single-screw extruder (φ=30 mm), thereby obtaining transparent pellets having a glass transition temperature of 127° C.

The pellets of the resin composition prepared as above were melt-extruded from a coat hanger-type T die by using a double-screw extruder, thereby preparing a resin film having a thickness of about 120 μm.

Then, the obtained un-stretched resin film was biaxially stretched in both a vertical direction (length direction) by a factor of 2.0 and a transverse direction (width direction) by a factor of 2.0, thereby preparing a polarizer protect film. The acryl substrate film obtained as above had a thickness of 30 μm, a total light transmittance of 92%, a haze of 0.25%, and a glass transition temperature of 127° C.

<Forming Hardcoat Layer by Coating>

By winding off the used transparent support in the form of roll and using the coating solutions for a hardcoat layer A01 to A25, hardcoat films S01 to S25 were prepared.

Specifically, by using the die coating method described in Example 1 in JP2006-122889A in which a slot die was used, the support was coated with each of the coating solutions for a hardcoat layer under the condition of a transport speed of 30 m/min, and the coating solution was dried for 150 seconds at 60° C. Then, with nitrogen purging, the coating solution was irradiated with ultraviolet rays at an irradiance of 400 mW/cm² and an irradiation amount of 500 mJ/cm² at an oxygen concentration of about 0.01% by volume by using an air-cooled metal halide lamp (manufactured by EYE GRAPHICS Co., Ltd.) at 160 W/cm. In this way, the coating layer was cured, and a hardcoat layer was formed and then wound up.

(Saponification of Film)

Among the prepared hardcoat films. S11 and S12 were subjected to a saponification treatment according to the following procedure.

The hardcoat film was immersed for 2 minutes in a 1.5 mol/L aqueous NaOH solution (saponification solution) kept at 45° C. and then rinsed with water. Thereafter, the film was immersed in an aqueous sulfuric acid solution of the following concentration with a temperature of 30° C. for 15 seconds and then bathed with water by being passed through running water for 100 seconds, thereby making the film neutral. Subsequently, the operation of blowing off water by using an air knife was repeated three times such that water was shaken off, and then the film was dried by being allowed to stay in a drying zone with a temperature of 90° C. for 60 seconds, thereby preparing a film having undergone a saponification treatment.

As the aqueous sulfuric acid solution, a 0.05 mol/L aqueous sulfuric acid solution was used for the hardcoat film S11, and a 0.25 mol/L aqueous sulfuric acid solution was used for the hardcoat film S12.

The prepared hardcoat films S01 to S25 were evaluated by the following evaluation method.

{Film Thickness of Hardcoat Layer}

By using a contact-type film thickness gauge, the film thickness of the prepared hardcoat film was measured, and the thickness of the transparent support measured in the same manner was subtracted from the film thickness of the hardcoat film, thereby calculating the film thickness of the hardcoat layer. In all of the hardcoat films S01 to S25, the film thickness of the hardcoat layer was 7.5 μm.

{Surface Condition of Hardcoat Layer}

A black tape for preventing rear surface reflection was bonded to a surface of the hardcoat film opposite to the hardcoat layer, the hardcoat film was visually observed from the surface of the hardcoat layer, and the surface condition was evaluated based on the following evaluation standards.

A: No interference fringe was observed.

B: Interference fringes were slightly observed.

C: Interference fringes slightly occurred, but the hardcoat film was acceptable as a product.

D: Interference fringes seriously occurred.

{Pencil Hardness}

The pencil hardness evaluation described in JIS K 5600-5-4 (1999) was performed. The hardcoat film was humidified for 2 hours at a temperature of 25° C. and a relative humidity of 60%. Then, by using 2H to 4H testing pencils specified in JIS S 6006 (2007), the hardcoat film was scraped 5 times with each pencil under a load of 4.9 N. At this time, the number of films that were not scratched was measured, and the pencil hardness was determined based on the following standards.

A: When the film was scraped 5 times with a 4H pencil, the number of times the film was scratched was 0 to 2.

B: When the film was scraped 5 times with a 3H pencil, the number of times the film was scratched was 0 to 2.

C: When the film was scraped 5 times with a 2H pencil, the number of times the film was scratched was 0 to 2.

D: When the film was scraped 5 times with a 2H pencil, the number of times the film was scratched was equal to or greater than 3, which is outside an acceptable range.

{Water Contact Angle}

By using a contact angle meter [“CA-X” type contact angle meter, manufactured by Kyowa Interface Science Co., LTD.], in a dry state (20° C., relative humidity of 65%), a liquid droplet having a diameter of 1.0 mm was formed at the tip of the stylus by using pure water as a liquid. The stylus was brought into contact with the surface of the hardcoat film such that a liquid droplet was formed on the film. By using the angle formed between a tangent touching the liquid surface and the film surface at a spot in which the film contacted the liquid, an angle of a side containing the liquid was measured and taken as a contact angle. Based on the result, the water contact angle was evaluated according to the following standards. For S11 and S12, the film obtained after saponification was used to measure the contact angle.

A: The contact angle was equal to or smaller than 50°.

B: The contact angle was greater than 50° and equal to or smaller than 75°.

C: The contact angle was greater than 75° and equal to or smaller than 85°

D: The contact angle was greater than 85°.

{Cissing at the Time of Lamination on Hardcoat Layer}

(Preparation of Coating Solution for Lamination Ln-1)

Components were mixed together as shown below and dissolved in a mixture of MEK/MMPG-Ac=90/10 (mass ratio), thereby preparing a coating solution for a layer of low refractive index with a solid content of 1% by mass.

<<Composition of Ln-1>>

| | |
|---|---|
| The following perfluoroolefin copolymer (P-1) | 15.0 g |
| DPHA | 7.0 g |
| RMS-033 | 5.0 g |
| The following fluorine-containing monomer (M-1) | 20.0 g |
| Hollow silica particles (as solid content) | 50.0 g |
| IRGACURE 127 | 3.0 g |

The used compounds are shown below.

Perfluoroolefin Copolymer (P-1)

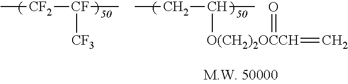

In the above structure formula, “50:50” represents a molar ratio.

Fluorine-Containing Monomer (M-1)

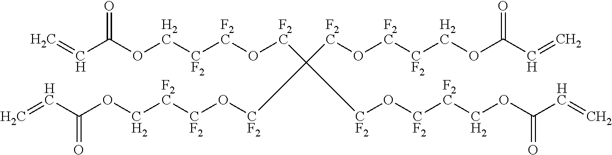 [SMILES: C=CC(=O)OCC(F)(F)C(F)(F)OC(F)(F)C(C(F)(F)OC(F)(F)C(F)(F)COC(=O)C=C)(C(F)(F)OC(F)(F)C(F)(F)COC(=O)C=C)C(F)(F)OC(F)(F)C(F)(F)COC(=O)C=C]

DPHA: KAYARAD DPHA (manufactured by Nippon Kayaku Co., Ltd.)
RMS-033: silicone-based polyfunctional acrylate (manufactured by Gelest, Inc, Mwt=28,000)
IRGACURE 127: acylphosphine oxide-based photopolymerization initiator (manufactured by BASF SE)
Hollow silica particles: hollow silica particle dispersion (average particle size: 45 nm, refractive index: 1.25, having a surface treated with a silane coupling agent containing an acryloyl group, concentration of MEK dispersion: 20%)
MEK: methyl ethyl ketone
MMPG-Ac: propylene glycol monomethyl ether acetate

The aforementioned coating solution for a layer of low refractive index was filtered through a filter made of polypropylene having a pore size of 1 μm, thereby preparing a coating solution.

Then, a side of the hardcoat film on which the hardcoat layer was formed by coating was coated with the coating solution for a layer of low refractive index Ln-1. For S11 and S12, a film obtained after saponification was used. The layer of low refractive index was dried under the condition of 90° C. and 60 seconds. Furthermore, with performing nitrogen purging so as to create an atmosphere with an oxygen concentration of equal to or lower than 0.01% by volume, ultraviolet curing was conducted using an air-cooled metal halide lamp (manufactured by EYE GRAPHICS Co., Ltd.) at 240 W/cm under the condition of an irradiance of 600 mW/cm² and an irradiation amount of 300 mJ/cm². The layer of low refractive index had a refractive index of 1.36 and a film thickness of 95 nm. In an area of 15 cm×20 cm within the obtained film, the number of cissing regions was counted. Herein, a region in which the overlayer was not formed within the surface of the underlayer was regarded as a cissing region. Based on the result, cissing was evaluated according to the following standards.

A: The number of cissing regions was equal to or less than 1.

B: The number of cissing regions was 2 to 4.

C: The number of cissing regions was equal to or more than 5.

As is evident from the results shown in the following Tables 1 to 4, the hardcoat film of the present invention has a small water contact angle on the surface thereof, has excellent surface condition and hardness, and hardly causes cissing of other layers when other layers are laminated on the hardcoat film.

TABLE 1

| | Coating solution for hardcoat layer | A01 | A02 | A03 | A04 | A05 | A06 |
|---|---|---|---|---|---|---|---|
| (c) | DPHA | 96.20% | 96.18% | 96.15% | 96.58% | 96.18% | 96.58% |
| Component | UV1700B | | | | | | |
| | A-DCP | | | | | | |
| (b) | Compound B-1 | 0.80% | 0.80% | 0.80% | 0.40% | | 0.40% |
| Component | B2380 | | | | | 0.80% | |
| (a) | A-1 (a:b = 50:50) | 0.005% | 0.020% | 0.050% | 0.020% | 0.020% | |
| Component | A-1 (a:b = 30:70) | | | | | | 0.020% |
| | A-1 (a:b = 10:90) | | | | | | |
| | A-2 | | | | | | |
| | A-3 | | | | | | |
| | A-4 | | | | | | |
| (g) | FTERGENT 610FM | | | | | | |
| Component | Compound G-1 | | | | | | |
| (d) | 3,4-Epoxycyclohexylmethyl methacrylate | | | | | | |
| Component | 3′,4′-epoxycyclohexylmethyl- | | | | | | |
| | 3,4-epoxycyclohexane carboxylate | | | | | | |
| | Glycidyl methacrylate | | | | | | |
| (h) | IRGACURE 184 | 3.00% | 3.00% | 3.00% | 3.00% | 3.00% | 3.00% |
| Component | | | | | | | |
| (e) | ELECOM V-8802 | | | | | | |
| Component | MiBK-ST | | | | | | |
| (f) | Tinuvin 928 | | | | | | |
| Component | | | | | | | |
| Solvent | MEK | 50% | 50% | 50% | 50% | 50% | 50% |
| | MiBK | 30% | 30% | 30% | 30% | 30% | 30% |
| | Methyl acetate | 20% | 20% | 20% | 20% | 20% | 20% |

| | | | | | | |
|---|---|---|---|---|---|---|
| Note | Example | Example | Example | Example | Example | Example |

| | | Film No. | | | | | |
|---|---|---|---|---|---|---|---|
| | | S01 | S02 | S03 | S04 | S05 | S06 |
| Hard coat coating solution No. | | A01 | A02 | A03 | A04 | A05 | A06 |
| Layer constitution | Support | 40 μm | 40 μm | 40 μm | 40 μm | 40 μm | 40 μm |
| | | TAC | TAC | TAC | TAC | TAC | TAC |
| | Film thickness of hardcoat layer (μm) | 7.5 | 7.5 | 7.5 | 7.5 | 7.5 | 7.5 |
| Evaluative result | Surface condition (smoothness) | C | B | A | B | B | B |
| | Contact angle after saponification | A | A | B | B | A | A |
| | Cissing at the time of lamination | A | A | B | B | A | A |
| | Pencil hardness | A | A | A | A | A | A |

TABLE 2

| | Coating solution for hardcoat layer | A07 | A08 | A09 | A10 | A11 | A12 |
|---|---|---|---|---|---|---|---|
| (c) | DPHA | 96.58% | 96.58% | 96.18% | 96.18% | 96.98% | 96.98% |
| Component | UV1700B | | | | | | |
| | A-DCP | | | | | | |
| (b) | Compound B-1 | 0.40% | 0.40% | 0.80% | 0.80% | | |
| Component | B2380 | | | | | | |
| (a) | A-1 (a:b = 50:50) | | | | | 0.020% | 0.020% |
| Component | A-1 (a:b = 30:70) | | | | | | |
| | A-1 (a:b = 10:90) | 0.020% | | | | | |
| | A-2 | | 0.020% | | | | |
| | A-3 | | | 0.020% | | | |
| | A-4 | | | | 0.020% | | |
| (g) | FTERGENT 610FM | | | | | | |
| Component | Compound G-1 | | | | | | |
| (d) | 3,4-Epoxycyclohexylmethyl methacrylate | | | | | | |
| Component | 3′,4′-epoxycyclohexylmethyl-3,4- | | | | | | |
| | epoxycyclohexane carboxylate | | | | | | |
| | Glycidyl methacrylate | | | | | | |
| (h) | IRGACURE 184 | 3.00% | 3.00% | 3.00% | 3.00% | 3.00% | 3.00% |
| Component | | | | | | | |
| (e) | ELECOM V-8802 | | | | | | |
| Component | MiBK-ST | | | | | | |
| (f) | Tinuvin 928 | | | | | | |
| Component | | | | | | | |
| Solvent | MEK | 50% | 50% | 50% | 50% | 50% | 50% |
| | MiBK | 30% | 30% | 30% | 30% | 30% | 30% |
| | Methyl acetate | 20% | 20% | 20% | 20% | 20% | 20% |

| | | | | | | |
|---|---|---|---|---|---|---|
| Note | Example | Example | Example | Example | Example | Example |

| | | Film No. | | | | | |
|---|---|---|---|---|---|---|---|
| | | S07 | S08 | S09 | S10 | S11 | S12 |
| Hard coat coating solution No. | | A07 | A08 | A09 | A10 | A11 | A12 |
| Layer constitution | Support | 40 μm | 40 μm | 40 μm | 40 μm | 40 μm | 40 μm |
| | | TAC | TAC | TAC | TAC | TAC | TAC |
| | Film thickness of hardcoat layer (μm) | 7.5 | 7.5 | 7.5 | 7.5 | 7.5 | 7.5 |
| Evaluative result | Surface condition (smoothness) | A | A | B | B | B | B |
| | Contact angle after saponification | A | A | A | B | B | A |
| | Cissing at the time of lamination | A | A | A | B | B | A |
| | Pencil hardness | A | A | A | A | A | A |

TABLE 3

| | Coating solution for hardcoat layer | A13 | A14 | A15 | A16 | A17 | A18 | A19 |
|---|---|---|---|---|---|---|---|---|
| (c) | DPHA | | | 96.18% | 73.18% | 73.18% | 73.18% | 58.18% |
| Component | UV1700B | 96.18% | | | | | | |
| | A-DCP | | 96.18% | | | | | |
| (b) | Compound B-1 | 0.80% | 0.80% | 0.80% | 0.80% | 0.80% | 0.80% | 0.80% |
| Component | B2380 | | | | | | | |
| (a) | A-1 (a:b = 50:50) | 0.020% | 0.020% | 0.020% | 0.020% | 0.020% | 0.020% | 0.020% |
| Component | A-1 (a:b = 30:70) | | | | | | | |
| | A-1 (a:b = 10:90) | | | | | | | |
| | A-2 | | | | | | | |
| | A-3 | | | | | | | |
| | A-4 | | | | | | | |
| (g) | FTERGENT 610FM | | | | | | | |
| Component | Compound G-1 | | | | | | | |
| (d) | 3,4-Epoxycyclohexylmethyl methacrylate | | | | 23.00% | | | 23.00% |
| Component | 3′,4′-epoxycyclohexylmethyl-3,4- | | | | | 23.00% | | |
| | epoxycyclohexane carboxylate | | | | | | | |
| | Glycidyl methacrylate | | | | | | 23.00% | |
| (h) | IRGACURE 184 | 3.00% | 3.00% | 3.00% | 3.00% | 3.00% | 3.00% | 3.00% |
| Component | | | | | | | | |
| (e) | ELECOM V-8802 | | | | | | | 15.00% |
| Component | MiBK-ST | | | | | | | |
| (f) | Tinuvin 928 | | | | | | | |
| Component | | | | | | | | |
| Solvent | MEK | 50% | 50% | 50% | 50% | 50% | 50% | 50% |
| | MiBK | 30% | 30% | 30% | 30% | 30% | 30% | 30% |
| | Methyl acetate | 20% | 20% | 20% | 20% | 20% | 20% | 20% |

| | | | | | | | |
|---|---|---|---|---|---|---|---|
| Note | Example | Example | Example | Example | Example | Example | Example |

| | | Film No. | | | | | | |
|---|---|---|---|---|---|---|---|---|
| | | S13 | S14 | S15 | S16 | S17 | S18 | S19 |
| Hard coat coating solution No | | A13 | A14 | A15 | A16 | A17 | A18 | A19 |
| Layer constitution | Support | 40 μm | 40 μm | 25 μm | 25 μm | 25 μm | 25 μm | 25 μm |
| | | TAC | TAC | TAC | TAC | TAC | TAC | TAC |
| | Film thickness of hardcoat layer (μm) | 7.5 | 7.5 | 7.5 | 7.5 | 7.5 | 7.5 | 7.5 |
| Evaluative result | Surface condition (smoothness) | B | B | B | A | A | A | A |
| | Contact angle after saponification | A | A | A | A | A | A | A |
| | Cissing at the time of lamination | A | A | A | A | A | A | A |
| | Pencil hardness | B | C | A | A | B | C | A |

TABLE 4

| | Coating solution for hardcoat layer | A20 | A21 | A22 | A23 | A24 | A25 |
|---|---|---|---|---|---|---|---|
| (c) | DPHA | 58.18% | 57.38% | 57.38% | 96.18% | 96.18% | 96.20% |
| Component | UV1700B | | | | | | |
| | A-DCP | | | | | | |
| (b) | Compound B-1 | 0.80% | 0.80% | 0.80% | 0.80% | 0.80% | 0.80% |
| Component | B2380 | | | | | | |
| (a) | A-1 (a:b = 50:50) | 0.020% | 0.020% | 0.020% | | | |
| Component | A-1 (a:b = 30:70) | | | | | | |
| | A-1 (a:b = 10:90) | | | | | | |
| | A-2 | | | | | | |
| | A-3 | | | | | | |
| | A-4 | | | | | | |
| (g) | FTERGENT 610FM | | | | 0.020% | | |
| Component | Compound G-1 | | | | | 0.020% | |
| (d) | 3,4-Epoxycyclohexylmethyl methacrylate | 23.00% | 23.00% | 23.00% | | | |
| Component | 3′,4′-epoxycyclohexylmethyl-3,4- | | | | | | |
| | epoxycyclohexane carboxylate | | | | | | |
| | Glycidyl methacrylate | | | | | | |
| (h) | IRGACURE 184 | 3.00% | 3.00% | 3.00% | 3.00% | 3.00% | 3.00% |
| Component | | | | | | | |
| (e) | ELECOM V-8802 | | 15.00% | 15.00% | | | |
| Component | MiBK-ST | 15.00% | | | | | |
| (f) | Tinuvin 928 | | 0.80% | 0.80% | | | |
| Component | | | | | | | |
| Solvent | MEK | 50% | 50% | 50% | 50% | 50% | 50% |
| | MiBK | 30% | 30% | 30% | 30% | 30% | 30% |
| | Methyl acetate | 20% | 20% | 20% | 20% | 20% | 20% |

| | | | | | | |
|---|---|---|---|---|---|---|
| Note | Example | Example | Example | Comparative | Comparative | Comparative |
| | | | | Example | Example | Example |

| | | Film No. | | | | | |
|---|---|---|---|---|---|---|---|
| | | S20 | S21 | S22 | S23 | S24 | S25 |
| Hard coat coating solution No. | | A20 | A21 | A22 | A23 | A24 | A25 |
| Layer constitution | Support | 25 μm | 25 μm | Acryl | 40 μm | 40 μm | 40 μm |
| | | TAC | TAC | substrate | TAC | TAC | TAC |
| | | | | film | | | |
| | Film thickness of hardcoat layer (μm) | 7.5 | 7.5 | 7.5 | 7.5 | 7.5 | 7.5 |
| Evaluative result | Surface condition (smoothness) | A | A | A | C | A | D |
| | Contact angle after saponification | A | A | A | C | D | B |
| | Cissing at the time of lamination | A | A | A | C | C | B |
| | Pencil hardness | A | A | A | A | A | A |

According to the present invention, it is possible to provide a hardcoat film, which has excellent surface condition and hardness, has a small water contact angle on a surface thereof, and exhibits excellent laminating properties with respect to other layers, and to provide a polarizing plate and a touch panel display having the hardcoat film.

Hitherto, the present invention has been specifically described with reference to specific embodiments. It is evident to those skilled in the related art that various changes or modifications can be added to the present invention without departing from the idea and scope of the present invention.

The present application is based on JP2015-089472 filed on Apr. 24, 2015, the content of which is incorporated herein by reference.

What is claimed is:

1. A hardcoat film comprising:
a support; and
a hardcoat layer on at least one surface of the support,
wherein the hardcoat layer is formed of a composition for forming a hardcoat layer containing:
(a) resin having a group which increases hydrophilicity when decomposed by an acid and a group which contains at least one kind of atom selected from a fluorine atom and a silicon atom; and
(b) acid generator.

2. A hardcoat film obtained by treating a hardcoat layer with an acid, the hardcoat layer disposed on at least one surface of a support,
wherein the hardcoat layer is formed of a composition for forming a hardcoat layer containing:
(a) resin having a group which increases hydrophilicity when decomposed by the acid and a group which contains at least one kind of atom selected from a fluorine atom and a silicon atom.

3. The hardcoat film according to claim 1,
wherein in the resin (a), the group which increases hydrophilicity when decomposed by the acid has a substituent which contains at least one kind of the atom selected from a fluorine atom and a silicon atom.

4. The hardcoat film according to claim 1,
wherein the composition for forming a hardcoat layer further contains:
(c) compound having three or more ethylenically unsaturated double bond groups.

5. The hardcoat film according to claim 1,
wherein the composition for forming a hardcoat layer further contains:
(d) compound having one or more epoxy groups.

6. The hardcoat film according to claim 5,
wherein the compound (d) has one alicyclic epoxy group and one ethylenically unsaturated double bond group in a molecule and having a molecular weight of equal to or less than 300.

7. The hardcoat film according to claim 1,
wherein the composition for forming a hardcoat layer further contains (e) inorganic fine particles reactive with an epoxy group or an ethylenically unsaturated double bond group.

8. The hardcoat film according to claim 1,
wherein the composition for forming a hardcoat layer further contains:
(f) ultraviolet absorber.

9. The hardcoat film according to claim 1,
wherein the support is a cellulose acylate film and has a thickness of equal to or less than 25 μm.

10. A polarizing plate comprising:
at least one sheet of the hardcoat film according to claim 1; and
a polarizer.

11. A touch panel display comprising:
a liquid crystal cell; and
the polarizing plate according to claim 10 on a viewing side of the liquid crystal cell.

12. The hardcoat film according to claim 2,
wherein in the resin (a), the group which increases hydrophilicity when decomposed by the acid has a substituent which contains at least one kind of the atom selected from a fluorine atom and a silicon atom.

13. The hardcoat film according to claim 2,
wherein the composition for forming a hardcoat layer further contains:
(c) compound having three or more ethylenically unsaturated double bond groups.

14. The hardcoat film according to claim 2,
wherein the composition for forming a hardcoat layer further contains:
(d) compound having one or more epoxy groups.

15. The hardcoat film according to claim 14,
wherein the compound (d) has one alicyclic epoxy group and one ethylenically unsaturated double bond group in a molecule and having a molecular weight of equal to or less than 300.

16. The hardcoat film according to claim 2,
wherein the composition for forming a hardcoat layer further contains (e) inorganic fine particles reactive with an epoxy group or an ethylenically unsaturated double bond group.

17. The hardcoat film according to claim 2,
wherein the composition for forming a hardcoat layer further contains:
(f) ultraviolet absorber.

18. The hardcoat film according to claim 2,
wherein the support is a cellulose acylate film and has a thickness of equal to or less than 25 μm.

19. A polarizing plate comprising:
at least one sheet of the hardcoat film according to claim 2; and
a polarizer.

20. A touch panel display comprising:
a liquid crystal cell; and
the polarizing plate according to claim 19 on a viewing side of the liquid crystal cell.
